(19) United States
(12) Patent Application Publication
(10) Pub. No.: US 2015/0184035 A1
(43) Pub. Date: Jul. 2, 2015

(54) TEMPORARY BONDING LAYER FOR PRODUCTION OF SEMICONDUCTOR DEVICE, STACK AND PRODUCTION METHOD OF SEMICONDUCTOR DEVICE

(71) Applicant: FUJIFILM Corporation, Tokyo (JP)

(72) Inventors: Ichiro KOYAMA, Haibara-gun (JP); Yu IWAI, Haibara-gun (JP); Kazuhiro FUJIMAKI, Haibara-gun (JP)

(73) Assignee: FUJIFILM Corporation, Tokyo (JP)

(21) Appl. No.: 14/658,395

(22) Filed: Mar. 16, 2015

Related U.S. Application Data
(63) Continuation of application No. PCT/JP2013/071983, filed on Aug. 15, 2013.

(30) Foreign Application Priority Data
Sep. 28, 2012 (JP) 2012-218586

(51) Int. Cl. C09J 7/02; B32B 37/12; C09J 145/00; B32B 38/10; C09J 125/06; B32B 37/18; B32B 38/00

(52) U.S. Cl. CPC C09J 7/0225; B32B 37/18; B32B 37/12; B32B 38/0036; B32B 38/10; C09J 125/06; C09J 145/00; B32B 2457/14; C09J 2425/00; C09J 2203/326

(57) ABSTRACT

As a temporary bonding layer for production of semiconductor device, which not only can temporarily support a member to be processed (for example, a semiconductor wafer) firmly and easily when the member to be processed is subjected to a mechanical or chemical processing, but also can easily release the temporary support for the member processed without imparting damage to the member processed, a stack and a production method of semiconductor device, a temporary bonding layer for production of semiconductor device including (A) a release layer and (B) an adhesive layer, wherein the release layer is a layer containing a hydrocarbon resin is provided.

### CROSS REFERENCE TO RELATED APPLICATION

This is a continuation of International Application No. PCT/JP2013/071983 filed on Aug. 15, 2013, and claims priority from Japanese Patent Application No. 2012-218586 filed on Sep. 28, 2012, the entire disclosures of which are incorporated herein by reference.

### TECHNICAL FIELD

The present invention relates to a temporary bonding layer for production of semiconductor device, a stack and a production method of semiconductor device.

### BACKGROUND ART

Heretofore, in the production process of semiconductor device, for example, IC or LSI, ordinarily, a large number of IC chips are formed on a semiconductor silicon wafer and diced by dicing.

With the needs for further miniaturization and higher performance of electronic devices, further miniaturization and higher integration of IC chip mounted on the electronic device are requested, however, the high integration of the integrated circuit in the plane direction of a silicon substrate is close to the limit.

As an electrical connection method from an integrated circuit in an IC chip to an external terminal of the IC chip, a wire bonding method has been heretofore widely known. In order to reduce the size of the IC chip, in recent years, a method where a through hole is provided in a silicone substrate and a metal plug, as the external terminal is connected to the integrated circuit so as to pass through the through hole (method of forming a so-called through-silicon electrode (TSV)) is known. However, according to the method of forming a through silicon-electrode alone, the needs of higher integration for IC chip in recent years as described above are not sufficiently fulfilled.

In the light of the above, a technique of improving the integration density per unit area of the silicon substrate by making the integrated circuit in IC chip multi-layered is known. However, since the multi-layered integrated circuit increases the thickness of the IC chip, reduction in the thickness of members constituting the IC chip is required. As to the reduction in the thickness of the member, for example, reduction in the thickness of the silicon substrate has been studied and is promising not only to lead to the miniaturization of IC chip but also to save labor in a through-hole producing step of the silicon substrate in the production of through-silicon electrode.

As a semiconductor silicon wafer used in a production process of semiconductor device, the semiconductor silicon wafer having a thickness from about 700 to about 900 μm is widely known. In recent years, for the purpose of miniaturization of IC chip, it has been attempted to reduce the thickness of semiconductor silicon wafer to 200 μm or less.

However, since the semiconductor silicon wafer having the thickness of 200 μm or less is very thin and thus, a member for producing semiconductor device using the semiconductor silicon wafer as a base material is also very thin, and in the case where the member is subjected to further processing or where the member is simply moved, it is difficult to support the member stably and without imparting damage to the member.

In order to solve the problem described above, a technique is known wherein a semiconductor wafer having a device provided on the surface thereof before thinning and a supporting substrate for processing is temporarily adhered to a supporting substance for processing with a silicone adhesive, a back surface of the semiconductor wafer is ground to make it thin, the semiconductor wafer is punched to provide a through-silicon electrode, and then the supporting substrate for processing is released from the semiconductor wafer (see Patent Document 1). It is described that according to the technique, resistance to grinding at the grind of back surface of the semiconductor wafer, heat resistance in an anisotropic dry etching step or the like, chemical resistance at plating and etching, smooth final release from the supporting substrate for processing and a low adherend contamination property are able to be achieved at the same time.

Also, as a method of supporting a wafer, a technique is known which is a method for supporting a wafer by a support layer system, wherein between the wafer and the support layer system, a plasma polymer layer obtained by a plasma deposition method is interposed as a separation layer, and an adhesion bonding between the support layer system and the separation layer is made larger than an adhesion bonding between the wafer and the separation layer so as to be easily released the wafer from the separation layer when the wafer is released from the support layer system (see Patent Document 2).

Also, a technique of performing temporary adhesion using a polyethersulfone and a viscosity imparting agent, and then releasing the temporary adhesion with heating is known (see Patent Document 3).

Also, a technique of performing temporary adhesion with a mixture composed of a carboxylic acid and an amine, and then releasing the temporary adhesion with heating is known (see Patent Document 4).

Also, a technique is known wherein a device wafer and a supporting substrate are bonded with pressure to be adhered in a state where an adhesion layer composed of a cellulose polymer and the like is heated, and then the device wafer is released from the supporting substrate by laterally sliding under heating (see Patent Document 5).

Also, an adhesion film composed of syndiotactic 1,2-polybutadiene and a photopolymerization initiator, an adhesive force of which is changed by irradiation of radiation is known (see Patent Document 6).

Further, a technique is known wherein a supporting substrate and a semiconductor wafer are temporary adhered with an adhesive composed of a polycarbonate, the semiconductor wafer is subjected to processing, and by irradiating active energy ray and then heating, the semiconductor wafer processed is released from the supporting substrate (see Patent Document 7).

Also, a technique of using a hydrocarbon resin as an adhesive for temporary adhesion is known (see Patent Document 8).

Also, a technique of using two layers of a layer composed of a compound which absorbs an infrared ray and an adhesive agent layer as an adhesive layer for temporary adhesion is known (see Patent Document 9).

Also, a technique of using two layers of an inorganic compound layer and an adhesive agent layer as an adhesive layer for temporary adhesion is known (see Patent Document 10).

Also, a technique of using two layers of a fluorocarbon layer and an adhesive agent layer as an adhesive layer for temporary adhesion is known (see Patent Document 11).

### PRIOR ART DOCUMENT

### Patent Document

Patent Document 1: JP-A-2011-119427 (the term “JP-A” as used herein means an “unexamined published Japanese patent application”)

Patent Document 2: JP-T-2009-528688 (the term “JP-T” as used herein means a published Japanese translation of a PCT patent application)

Patent Document 3: JP-A-2011-225814

Patent Document 4: JP-A-2011-52142

Patent Document 5: JP-T-2010-506406

Patent Document 6: JP-A-2007-45939

Patent Document 7: U.S. Patent Publication No. 2011/0318938

Patent Document 8: JP-A-2011-219506

Patent Document 9: JP-A-2012-124467

Patent Document 10: JP-A-2012-109538 Patent Document 11: JP-A-2012-109519

### DISCLOSURE OF THE INVENTION

### Problems that the Invention is to Solve

In the case where a surface of semiconductor wafer provided with a device (that is, a device surface of device wafer) and a supporting substrate (that is, a carrier substrate) are temporarily adhered through a layer composed of the adhesive known in Patent Document 1 or the like, the adhesion of a certain strength is required for the adhesive layer in order to stably support the semiconductor wafer.

Therefore, in the case where the whole device surface of the semiconductor wafer and the supporting substrate are temporarily adhered through the adhesive layer, when the temporary adhesion between the semiconductor wafer and the supporting substrate is made sufficient in order to support the semiconductor wafer stably and without imparting damage to the semiconductor wafer, due to the too strong temporary adhesion between the semiconductor wafer and the supporting substrate, on the other hand, a disadvantage in that the device is damaged or in that the device is released from the semiconductor wafer is likely to occur, when the semiconductor wafer is released from the supporting substrate.

Also, the method of forming as a separation layer, a plasma polymer layer by a plasma deposition method between the wafer and the support layer system as in Patent Document 2 in order to prevent that the adhesion between the wafer and the support layer system becomes too strong has problems (1) in that the equipment cost for performing the plasma deposition method is ordinarily high, (2) in that the layer formation by the plasma deposition method takes time for vacuumization in the plasma apparatus and deposition of monomer, and (3) in that even when the separation layer composed of a plasma polymer layer is provided, it is not easy to control the adhesion bonding in such a manner that the wafer is easily released from the separation layer in the case of releasing the supporting of wafer, while, on the other hand, the adhesion bonding between the wafer and the separation layer maintains sufficiently in the case of supporting the wafer subjected to the processing.

Also, the method of releasing the temporary adhesion with heating as described in Patent Documents 3, 4 and 5, a disadvantage in that the device is damaged is likely to occur, when the semiconductor wafer is released.

Also, in the method of releasing the temporary adhesion by irradiation of active energy ray as described in Patent Documents 6 and 7, it is necessary to use a supporting substrate which transmits the active energy ray.

Also, in the case of using only a hydrocarbon resin layer as the adhesive as described in Patent Document 8, the adhesion property of the adhesive is insufficient.

Also, in the method of releasing the temporary adhesion by irradiation of active energy ray, for example, an infrared ray, as described in Patent Document 9, it is necessary to provide a supporting substrate which transmits the active energy ray.

Also, in the case of using an inorganic compound layer as described in Patent Document 10, it is difficult to completely remove the inorganic compound layer to be more likely to cause defects in semiconductor.

Also, in the case of using a fluorocarbon layer as described in Patent Document 11, a separate equipment for forming the fluorocarbon layer is necessary to bring about decrease in productivity.

The invention has been made in the light of the background described above, and an object of the invention is to provide a temporary bonding layer for production of semiconductor device, which not only can temporarily support a member to be processed (for example, a semiconductor wafer) firmly and easily when the member to be processed is subjected to a mechanical or chemical processing, but also can easily release the temporary support for the member processed without imparting damage to the member processed, and a stack and a production method of semiconductor device.

### Means for Solving the Problems

As a result of the intensive investigations to solve the problems described above, the inventors have found that by providing a hydrocarbon resin layer and an adhesive layer between a support and a member to be processed, high durability to physical stimulus, for example, polishing or heating is achieved and at the release, the temporary support for the member processed can be easily released by bringing the adhesive layer into contact with a release solvent without conducting heating or irradiation of active light or radiation as conducting in the prior art described above, to complete the invention. Specifically, the invention includes the following items.

[1]

A temporary bonding layer for production of semiconductor device including (A) a release layer and (B) an adhesive layer, wherein the release layer is a layer containing a hydrocarbon resin.

[2]

The temporary bonding layer for production of semiconductor device as described in [1], wherein the hydrocarbon resin is at least one resin selected from the group consisting of an olefin polymer, a terpene resin, rosin and a petroleum resin.

[3]

The temporary bonding layer for production of semiconductor device as described in [1] or [2], wherein the hydrocarbon resin is a polystyrene resin or a cyclic olefin polymer.

[4]

The temporary bonding layer for production of semiconductor device as described in any one of [1] to [3], wherein the adhesive layer contains a binder, a polymerizable monomer, and at least one of a photopolymerization initiator and a heat polymerization initiator.

[5]

A stack comprising a support, a member to be processed, and the temporary bonding layer for production of semiconductor device as described in any one of [1] to [4] which is provided between the support and the member to be processed.

[6]

A production method of semiconductor device having a member processed comprising a step of adhering a first surface of a member to be processed to a substrate in such a manner that the temporary bonding layer for production of semiconductor device as described in any one of [1] to [4] is intervened between the first surface of a member to be processed and the substrate, a step of conducting a mechanical or chemical processing on a second surface which is different from the first surface of the member to be processed to obtain the member processed, and a step of releasing the member processed from the temporary bonding layer.

[7]

The production method of semiconductor device as described in [6], which further comprises a step of irradiating active light or radiation, or heat to the adhesive layer of the temporary bonding layer, before the step of adhering.

[8]

The production method of semiconductor device as described in [6] or [7], which further comprises a step of heating the temporary bonding layer at a temperature from 50 to 300° C., after the step of adhering and before the step of conducting a mechanical or chemical processing.

[9]

The production method of semiconductor device as described in any one of [6] to [8], wherein the step of releasing the member processed from the temporary bonding layer includes a step of bringing the temporary bonding layer into contact with a release solvent.

[10]

The production method of semiconductor device as described in [9], wherein the release solvent is at least one solvent selected from the group consisting of a hydrocarbon solvent and an ether solvent.

[11]

The production method of semiconductor device as described in [10], wherein the release solvent is at least one solvent selected form the group consisting of cyclopentane, n-hexane, cyclohexane, n-heptane, limonene, p-menthane and tetrahydrofuran.

### Advantage of the Invention

According to the invention, a temporary bonding layer for production of semiconductor device, which not only can temporarily support a member to be processed firmly and easily when the member to be processed is subjected to a mechanical or chemical processing, but also can release the temporary support for the member processed without imparting damage to the member processed, and a stack and a production method of semiconductor device can be provided.

### BRIEF DESCRIPTION OF THE DRAWING

FIG. 1A, FIG. 1B and FIG. 1C are a schematic cross-sectional view illustrating temporary adhesion of an adhesive support and a device wafer, a schematic cross-sectional view showing the device wafer temporarily adhered by the adhesive support and a schematic cross-sectional view showing a state in which the device wafer temporarily adhered by the adhesive support is thinned, respectively.

FIG. 2 is a schematic cross-sectional view illustrating release of a temporary adhering state between a conventional adhesive support and a device wafer.

FIG. 3A shows a schematic cross-sectional view illustrating exposure of the adhesive support, and FIG. 3B shows a schematic top view of a mask.

FIG. 4A shows a schematic cross-sectional view of the adhesive support subjected to pattern exposure, and FIG. 4B shows a schematic top view of the adhesive support subjected to pattern exposure.

FIG. 5 shows a schematic cross-sectional view illustrating irradiation of active light or radiation, or heat to the adhesive support.

### DESCRIPTION OF REFERENCE NUMERALS AND SIGNS

11, 11′, 21, 31: Adhesive layer
12: Carrier substrate
21A, 31A: Low adhesive region
21B, 31B: High adhesive region
31a: Outer surface of adhesive layer
31b: Inner surface of adhesive layer
40: Mask
41: Light-transmitting region
42: Light-shielding region
50: Active light or radiation
50′: Active light or radiation, or heat
60: Device wafer
60′: Thin device wafer
61: Silicon substrate
61a: Surface of silicon substrate
61b: Rear surface of silicon substrate
61b′: Rear surface of thin device wafer
62: Device chip
63: Bump
70: Tape
71: Release layer
80: Temporary bonding layer
100, 100′, 110, 120: Adhesive support

### MODE FOR CARRYING OUT THE INVENTION

Embodiments of the invention will be described in detail hereinafter.

In the description of a group (atomic group) in the specification, when the group is described without specifying whether the group is substituted or unsubstituted, the group includes both a group (atomic group) having no substituent and a group (atomic group) having a substituent. For example, “an alkyl group” includes not only an alkyl group which has no substituent (an unsubstituted alkyl group) but also an alkyl group which has a substituent (a substituted alkyl group).

In the specification, the term “active light” or “radiation” includes, for example, visible light, an ultraviolet ray, a far ultraviolet ray, an electron beam and an X-ray. Also, the term “light” as used in the invention means active light or radiation.

Also, the term “exposure” in the specification includes, unless otherwise specified, not only exposure by a mercury lamp, an ultraviolet ray, a far ultraviolet ray represented by an excimer laser, an X-ray, EUV light or the like, but also drawing by a particle ray, for example, an electron beam or an ion beam.

Also, in the specification, the term “(meth)acrylate” represents both or either of acrylate and methacrylate, the term “(meth)acryl” represents both or either of acryl and methacryl, and the term “(meth)acryloyl” represents both or either of acryloyl and methacryloyl. Also, in the specification, the terms “monomer” and “monomer” have the same meaning. A monomer according to the invention is distinguished from an oligomer and a polymer, and means a compound having a weight average molecular weight of 2,000 or less. In the specification, a polymerizable compound indicates a compound having a polymerizable group, and may be a monomer or a polymer. The polymerizable group denotes a group which is involved in a polymerization reaction.

In the embodiments described below, the member or the like described in the drawing already referred to is indicated by the same or corresponding symbol in the figure and its description is simplified or omitted.

The temporary bonding layer for production of semiconductor device (hereinafter, also simply referred to as a “temporary bonding layer”) according to the invention includes (A) a release layer and (B) an adhesive layer.

In accordance with the temporary bonding layer for production of semiconductor device according to the invention, a temporary bonding layer for production of semiconductor device which not only can temporarily support firmly and easily a member to be processed when the member to be processed is subjected to a mechanical or chemical processing described in detail later, but also can release the temporary support for the member processed without imparting damage to the member processed can be obtained.

The temporary bonding layer for production of semiconductor device according to the invention is preferred for forming a through-silicon electrode. The formation of through-silicon electrode will be described in detail later.

### (A) Release Layer

The release layer is used for the purpose of increasing a releasing property due to a release solvent described later. Therefore, the release layer is required to exhibits a small change in the adhesion property due to heat and chemicals and on the other hand, to have a good solubility in the release solvent. The release layer contains a hydrocarbon resin.

The release layer can be formed by coating a release layer composition containing the hydrocarbon resin and a solvent on a member to be processed by using a conventionally known method, for example, a spin coating method, a spraying method, a roller coating method, a flow coating method, a doctor coating method or a dipping method, followed by drying.

The thickness of the release layer is, for example, in a range from 1 to 500 μm, and it is not particularly limited.

Hereinafter, the hydrocarbon resin which is contained in the release layer composition is described.

As the hydrocarbon resin which is contained in the release layer composition, an appropriate hydrocarbon resin can be used in the invention.

The hydrocarbon resin according to the invention essentially means a resin composed of only carbon atoms and hydrogen atoms, but it may contain other atoms in its side chain as long as the essential skeleton is a hydrocarbon resin. The hydrocarbon resin according to the invention does not include a resin in which a functional group other than a hydrocarbon group is directly connected to the main chain, for example, an acrylic resin, a polyvinyl alcohol resin, a polyvinyl acetal resin or a polyvinyl pyrrolidone resin.

The hydrocarbon resin which fulfils the condition described above includes, for example, a polystyrene resin, a terpene resin, a terpene phenol resin, a modified terpene resin, a hydrogenated terpene resin, a hydrogenated terpene phenol resin, rosin, a rosin ester, a hydrogenated rosin, a hydrogenated rosin ester, a polymerized rosin, a polymerized rosin ester, a modified rosin, a rosin-modified phenol resin, an alkylphenol resin, a petroleum resin (for example, an aliphatic petroleum resin, an aromatic petroleum resin, a hydrogenated petroleum resin, a modified petroleum resin, an alicyclic petroleum resin, a coumarone petroleum resin or an indene petroleum resin), an olefin polymer (for example, a methylpentene copolymer), and a cyclic olefin polymer (for example, a norbornene copolymer, a dicyclopentadiene copolymer or a tetracyclododecene copolymer).

Of the resins, a polystyrene resin, a terpene resin, rosin, a petroleum resin, a hydrogenated rosin, a polymerized rosin, an olefin polymer and a cyclic olefin polymer are preferred, a polystyrene resin, a terpene resin, rosin, an olefin polymer, a petroleum resin and a cyclic olefin polymer are more preferred, a polystyrene resin, a terpene resin, rosin, an olefin polymer, a polystyrene resin and a cyclic olefin polymer are still more preferred, a polystyrene resin, a terpene resin, rosin, a cyclic olefin polymer and an olefin polymer are particularly preferred, and a polystyrene resin and a cyclic olefin polymer are most preferred.

Examples of the cyclic olefin resin used for production of the cyclic olefin polymer include a norbornene polymer, a polymer of monocyclic olefin, a polymer of cyclic conjugated diene, vinyl alicyclic hydrocarbon polymer and hydrogenated compounds of these polymers. Preferred examples thereof include an addition (co)polymer cyclic olefin resin containing at least one repeating unit represented by formula (II) shown below and an addition (co)polymer cyclic olefin resin further containing at least one repeating unit represented by formula (I) shown below, if desired. Also, other preferred examples thereof include a ring-opening (co)polymer containing at least one cyclic repeating unit represented by formula (III) shown below.

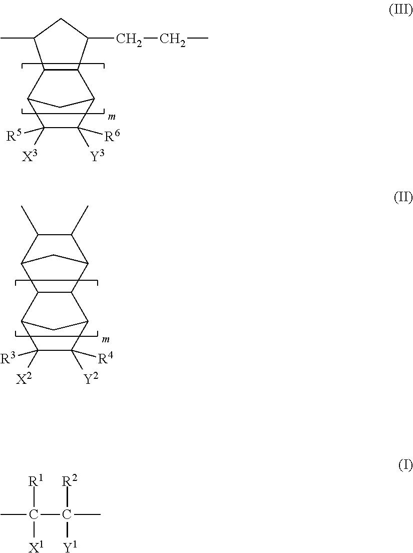

In the formulae, m represents an integer from 0 to 4, R¹ to R⁶ each represents a hydrogen atom or a hydrocarbon group having from 1 to 10 carbon atoms, X¹ to X³ and Y¹ to Y³ each represents a hydrogen atom, a hydrocarbon group having from 1 to 10 carbon atoms, a halogen atom, a hydrocarbon group having from 1 to 10 carbon atoms substituted with a halogen atom, —(CH₂)ₙCOOR¹¹, —(CH₂)ₙOCOR¹², —(CH₂)ₙNCO, —(CH₂)ₙNO₂, —(CH₂)ₙCN, —(CH₂)ₙCONR¹³R¹⁴, —(CH₂)ₙNR¹⁵R¹⁶, —(CH₂)ₙOZ, —(CH₂)ₙW, or (—CO)₂O or (—CO)₂NR¹⁷, each of which is constituted and X¹ and Y¹, X² and Y² or X³ and Y³, R¹¹, R¹², R¹³, R¹⁴, R¹⁵, R¹⁶ and R¹⁷ each represents a hydrogen atom or a hydrocarbon group having from 1 to 20 carbon atoms, Z represents a hydrocarbon group or a hydrocarbon group substituted with a halogen atom, W represents SiR¹⁸ₚD₃₋ₚ (R¹⁸ represents a hydrocarbon group having from 1 to 10 carbon atoms, D represents a halogen atom, —OCOR¹⁸ or —OR¹⁸, p represents an integer from 0 to 3), and n represents an integer from 0 to 10.

The norbornene addition (co)polymers are disclosed, for example, in JP-A-10-7732, JP-T-2002-504184, US 2004/229157A1 and WO 2004/070463A1. The norbornene addition (co)polymer is obtained by addition polymerization of norbornene polycyclic unsaturated compounds to each other. Also, if desired, the norbornene polycyclic unsaturated compound can be addition-polymerized with ethylene, propylene, butene; a conjugated diene, for example, butadiene or isoprene; or a non-conjugated diene, for example, ethylidene norbornene. The norbornene addition (co)polymer is marketed under the trade name of APEL from Mitsui Chemicals, Inc. including the grades having different glass transition temperature (Tg), for example, APL 8008T (Tg 70° C.), APL 6013T (Tg 125° C.) and APL 6015T (Tg 145° C.). Pellets, for example, TOPAS 8007, TOPAS 5013, TOPAS 6013 and TOPAS 6015 are marketed from Polyplastics Co., Ltd.

Further, Appear 3000 is marketed from Ferrania S.p.A.

The hydrogenated product of norbornene polymer can be produced by addition polymerization or metathesis ring opening polymerization of the polycyclic unsaturated compound, followed by hydrogenation as disclosed, for example, in JP-A-1-240517, JP-A-7-196736, JP-A-60-26024, JP-A-62-19801, JP-A-2003-159767 and JP-A-2004-309979.

In the formulae above, each of R⁵ and R⁶ is preferably a hydrogen atom or —CH₃, each of X³ and Y³ is preferably a hydrogen atom, and other groups are appropriately selected. The norbornene resins are marketed under the trade names of ARTON G and ARTON F from JSR Corp., and under the trade names of ZEONOR ZF14, ZEONOR ZF16, ZEONEX 250, ZEONEX 280 and ZEONEX 480R from Zeon Corp., and these can be used.

As the hydrocarbon resin, CLEARON P-135 (produced by Yasuhara Chemical Co., Ltd.), ZEONEX 480R (produced by Zeon Corp.), TOPAS 5013 (produced by Polyplastics Co., Ltd.), TPX-MX002 (produced by Mitsui Chemicals, Inc.), polystyrene (molecular weight: 190,000, produced by Sigma-Aldrich Corp.) and PENSEL KK (produced by Arakawa Chemical Industries, Ltd.) are preferably exemplified.

The hydrocarbon resin may be used only one kind or in combination of two or more kinds thereof.

The content of the hydrocarbon resin is preferably from 70 to 100% by weight, more preferably from 80 to 100% by weight, based on the total solid content of the release layer composition.

As the solvent, known solvents can be used without limitation as long as it can form the release layer. For example, limonene, cyclopentane, cyclohexane, PGMEA, mesitylene, xylene and p-menthane are used, and limonene, cyclopentane or PGMEA is preferred.

The solvent is preferably used so that the solid content concentration of the release layer composition becomes from 10 to 40% by weight.

The release layer composition may further contain a surfactant.

To the release layer composition according to the invention may be added various surfactants from the standpoint of more increasing the coating property. As the surfactant, various surfactants, for example, a fluorine-based surfactant, a nonionic surfactant, a cationic surfactant, an anionic surfactant or a silicone-based surfactant can be used.

In particular, by containing a fluorine-based surfactant in the release layer composition according to the invention, the liquid characteristic (particularly, fluidity) of a coating solution prepared is more increased so that the uniformity of coating thickness or the liquid-saving property can be more improved.

Specifically, in the case of forming a film by using the release layer composition containing a fluorine-based surfactant, the interface tension between a surface to be coated and the coating solution is reduced, whereby wettability to the surface to be coated is improved and the coating property on the surface to be coated is increased. This is effective in that even when a thin film of about several μm is formed using a small liquid volume, formation of the film having a little thickness unevenness and a uniform thickness can be performed in a more preferable manner.

The fluorine content in the fluorine-based surfactant is preferably from 3 to 40% by weight, more preferably from 5 to 30% by weight, and particularly preferably from 7 to 25% by weight. The fluorine-based surfactant having the fluorine content in the range described above is effective in view of the uniformity of coating thickness and the liquid-saving property and also exhibits good solubility in the release layer composition.

Examples of the fluorine-based surfactant include MEGAFAC F171, MEGAFAC F172, MEGAFAC F173, MEGAFAC F176, MEGAFAC F177, MEGAFAC F141, MEGAFAC F142, MEGAFAC F143, MEGAFAC F144, MEGAFAC R30, MEGAFAC F437, MEGAFAC F475, MEGAFAC F479, MEGAFAC F482, MEGAFAC F554, MEGAFAC F780 and MEGAFAC F781 (produced by DIC Corp.), FLUORAD FC430, FLUORAD FC431 and FLUORAD FC171 (produced by Sumitomo 3M Ltd.), SURFLON S-382, SURFLON SC-101, SURFLON SC-103, SURFLON SC-104, SURFLON SC-105, SURFLON SC-1068, SURFLON SC-381, SURFLON SC-383, SURFLON 5393 and SURFLON KH-40 (produced by Asahi Glass Co., Ltd.), and PF636, PF656, PF6320, PF6520 and PF7002 (produced by OMNOVA Solutions Inc.).

Specific examples of the nonionic surfactant include glycerol, trimethylolpropane, trimethylolethane, their ethoxylate and propoxylate (for example, glycerol propoxylate or glycerol ethoxylate), polyoxyethylene lauryl ether, polyoxyethylene stearyl ether, polyoxyethylene oleyl ether, polyoxyethylene octylphenyl ether, polyoxyethylene nonylphenyl ether, polyethylene glycol dilaurate, polyethylene glycol distearate, and a sorbitan fatty acid ester (PLURONIC L10, L31, L61, L62, 10R5, 17R2 and 25R2 and TETRONIC 304, 701, 704, 901, 904 and 150R1 (produced by BASF Corp.) and SOLSPERSE 20000 (produced by The Lubrizol Corp.)).

Specific examples of the cationic surfactant include a phthalocyanine derivative (EFKA-745, produced by Morishita Sangyo K.K.), an organosiloxane polymer (KP341, produced by Shin-Etsu Chemical Co., Ltd.), a (meth)acrylic acid (co)polymer (POLYFLOW No. 75, No. 90 and No. 95 (produced by Kyoeisha Chemical Co., Ltd.) and W001 (produced by Yusho Co., Ltd.).

Specific examples of the anionic surfactant include W004, W005 and W017 (produced by Yusho Co., Ltd.).

Examples of the silicone-based surfactant include TORAY SILICONE DC3PA, TORAY SILICONE SH7PA, TORAY SILICONE DC11PA, TORAY SILICONE SH21PA, TORAY SILICONE SH28PA, TORAY SILICONE SH29PA, TORAY SILICONE SH30PA and TORAY SILICONE SH8400 (produced by Dow Corning Toray Co., Ltd.), TSF-4440, TSF-4300, TSF-4445, TSF-4460 and TSF-4452 (produced by Momentive Performance Materials Inc.), KP341, KF6001 and KF6002 (produced by Shin-Etsu Silicone Co., Ltd.), and BYK307, BYK323 and BYK330 (produced by BYK-Chemie GmbH).

The surfactants may be used only one kind or in combination of two or more kinds thereof.

The amount of the surfactant added is preferably from 0.001 to 2.0% by weight, more preferably from 0.005 to 1.0% by weight, based on the total solid content of the release layer composition.

### (B) Adhesive Layer

The adhesive layer is used for the purpose of connecting the release layer and the substrate. Therefore, the adhesive layer is required to exhibits a small change in the adhesion property due to heat and chemicals.

The adhesive layer can be formed by coating a adhesive composition containing each component described later on a carrier substrate by using a conventionally known method, for example, a spin coating method, a spraying method, a roller coating method, a flow coating method, a doctor coating method or a dipping method, followed by drying.

The thickness of the adhesive layer is, for example, in a range from 1 to 500 μm, and it is not particularly limited.

The adhesive composition (therefore the adhesive layer) preferably contains a binder.

As the binder of the adhesive composition (therefore the adhesive layer), an appropriate binder can be used.

For instance, a synthetic resin, for example, the hydrocarbon resin described above, a novolac resin, a phenol resin, an epoxy resin, a melamine resin, a urea resin, an unsaturated polyester resin, an alkyd resin, polyurethane, polyimide, polyethylene, polypropylene, polyvinyl chloride, polystyrene, polyvinyl acetate, Teflon (registered trademark), an ABS resin, an AS resin, an acrylic resin, polyamide, polyacetal, polycarbonate, polyphenylene ether, polybutylene terephthalate, polyethylene terephthalate, cyclic polyolefin, polyphenylene sulfide, polysulfone, polyether sulfone, polyarylate, polyether ether ketone or polyamideimide, and a natural resin, for example, a natural rubber are exemplified. Of the resins, a polyurethane, a novolac resin, a polyimide and a polystyrene are preferred, a polyurethane, a novolac resin and a polyimide are more preferred, and a polyurethane is most preferred.

In the invention, the binders may be used in combination of two or more thereof, if desired.

The adhesive composition (therefore the adhesive layer) preferably contains a polymerizable monomer.

As the polymerizable monomer for the adhesive composition (therefore the adhesive layer), an appropriate polymerizable monomer can be used. The polymerizable monomer has a polymerizable group. The polymerizable group is typically a group capable of polymerizing by the irradiation of active light or radiation or the action of a radical or an acid. The polymerizable monomer is a compound different from the binder described above. The polymerizable monomer is typically a low molecular weight compound, preferably a low molecular weight compound having a molecular weight of 2,000 or less, more preferably a low molecular weight compound having a molecular weight of 1,500 or less, and still more preferably a low molecular weight compound having a molecular weight of 900 or less. The molecular weight of the polymerizable monomer is ordinarily 100 or more.

The polymerizable group is preferably, for example, a functional group capable of undergoing an addition polymerization reaction. The functional group capable of undergoing an addition polymerization reaction includes, for example, an ethylenically unsaturated bond group, an amino group and an epoxy group. Also, the polymerizable group may be a functional group capable of generating a radical by irradiation of light, and such a polymerizable group includes, for example, a thiol group and a halogen atom. Of the polymerizable groups, an ethylenically unsaturated bond group is preferred. The ethylenically unsaturated bond group preferably includes a styryl group, a (meth)acryloyl group and an allyl group.

A reactive compound having a polymerizable group includes a radical polymerizable compound (B1) and an ionic polymerizable compound (B2).

The radical polymerizable compound is specifically selected from compounds having at least one, preferably two or more radical polymerizable groups. Such compounds are widely known in the field of art and they can be used in the invention without any particular limitation. The compound has a chemical form, for example, a monomer, a prepolymer, specifically, a dimer, a trimer or an oligomer, or a mixture thereof, or a multimer thereof. The radical polymerizable compounds may be used individually or in combination of two or more thereof in the invention.

The radical polymerizable group is preferably an ethylenically unsaturated group. As the ethylenically unsaturated group, a styryl group, a (meth)acryloyl group or an allyl group is preferred.

More specifically, examples of the monomer and prepolymer include an unsaturated carboxylic acid (for example, acrylic acid, methacrylic acid, itaconic acid, crotonic acid, isocrotonic acid or maleic acid) and an ester, amide or multimer thereof. Preferably, an ester of an unsaturated carboxylic acid with a polyhydric alcohol compound, an amide of an unsaturated carboxylic acid with a polyvalent amine compound and a multimer thereof are exemplified. An addition reaction product of an unsaturated carboxylic acid ester or amide having a nucleophilic substituent, for example, a hydroxy group, an amino group or a mercapto group, with a monofunctional or polyfunctional isocyanate or epoxy, or a dehydration condensation reaction product of the unsaturated carboxylic acid ester or amide with a monofunctional or polyfunctional carboxylic acid is also preferably used. Further, an addition reaction product of an unsaturated carboxylic acid ester or amide having an electrophilic substituent, for example, an isocyanate group or an epoxy group with a monofunctional or polyfunctional alcohol, amine or thiol, or a substitution reaction product of an unsaturated carboxylic acid ester or amide having a releasable substituent, for example, a halogen atom or a tosyloxy group with a monofunctional or polyfunctional alcohol, amine or thiol is also preferred. As other examples, compounds in which the unsaturated carboxylic acid described above is replaced by an unsaturated phosphonic acid, a vinylbenzene derivative, for example, styrene, vinyl ether, allyl ether or the like may also be used.

With respect to specific examples of the monomer, which is an ester of a polyhydric alcohol compound with an unsaturated carboxylic acid, as an acrylic acid ester, for example, ethylene glycol diacrylate, triethylene glycol diacrylate, 1,3-butanediol diacrylate, tetramethylene glycol diacrylate, propylene glycol diacrylate, neopentyl glycol diacrylate, trimethylolpropane triacrylate, trimethylolpropane tri(acryloyloxypropyl) ether, trimethylolethane triacrylate, hexanediol diacrylate, 1,4-cyclohexanediol diacrylate, tetraethylene glycol diacrylate, pentaerythritol diacrylate, pentaerythritol triacrylate, dipentaerythritol diacrylate, dipentaerythritol hexaacrylate, pentaerythritol tetraacrylate, sorbitol triacrylate, sorbitol tetraacrylate, sorbitol pentaacrylate, sorbitol hexaacrylate, tri(acryloyloxyethyl) isocyanurate, isocyanuric acid ethylene oxide (EO) modified triacrylate and polyester acrylate oligomer are exemplified.

As a methacrylic acid ester, for example, tetramethylene glycol dimethacrylate, triethylene glycol dimethacrylate, neopentyl glycol dimethacrylate, trimethylolpropane trimethacrylate, trimethylolethane trimethacrylate, ethylene glycol dimethacrylate, 1,3-butanediol dimethacrylate, hexanediol dimethacrylate, pentaerythritol dimethacrylate, pentaerythritol trimethacrylate, pentaerythritol tetramethacrylate, dipentaerythritol dimethacrylate, dipentaerythritol hexamethacrylate, sorbitol trimethacrylate, sorbitol tetramethacrylate, bis[p-(3-methacryloxy-2-hydroxypropoxy)phenyl]dimethylmethane and bis[p-(methacryloxyethoxy)phenyl]dimethylmethane are exemplified.

As an itaconic acid ester, for example, ethylene glycol diitaconate, propylene glycol diitaconate, 1,3-butanediol diitaconate, 1,4-butanediol diitaconate, tetramethylene glycol diitaconate, pentaerythritol diitaconate and sorbitol tetraitaconate are exemplified.

As a crotonic acid ester, for example, ethylene glycol dicrotonate, tetramethylene glycol dicrotonate, pentaerythritol dicrotonate and sorbitol tetracrotonate are exemplified.

As an isocrotonic acid ester, for example, ethylene glycol diisocrotonate, pentaerythritol diisocrotonate and sorbitol tetraisocrotonate are exemplified.

As a maleic acid ester, for example, ethylene glycol dimaleate, triethylene glycol dimaleate, pentaerythritol dimaleate or sorbitol tetramaleate are exemplified.

As other examples of the ester, aliphatic alcohol esters described in JP-B-46-27926 (the term “JP-B” as used herein means an “examined Japanese patent publication”), JP-B-51-47334 and JP-A-57-196231, esters having an aromatic skeleton described in JP-A-59-5240, JP-A-59-5241 and JP-A-2-226149, and esters containing an amino group described in JP-A-1-165613.

Specific examples of the monomer, which is an amide of a polyvalent amine compound with an unsaturated carboxylic acid, include methylene bisacrylamide, methylene bismethacrylamide, 1,6-hexamethylene bisacrylamide, 1,6-hexamethylene bismethacrylamide, diethylenetriamine trisacrylamide, xylylene bisacrylamide and xylylene bismethacrylamide.

Other preferred examples of the amide monomer include amides having a cyclohexylene structure described in JP-B-54-21726.

Urethane type addition polymerizable compounds produced using an addition reaction between an isocyanate and a hydroxy group are also preferably used, and specific examples thereof include vinylurethane compounds having two or more polymerizable vinyl groups per molecule obtained by adding a vinyl monomer containing a hydroxy group represented by formula (A) shown below to a polyisocyanate compound having two or more isocyanate groups per molecule, described in JP-B-48-41708.

CH₂═C(R₄)COOCH₂CH(R₅)OH (A)

wherein R₄ and R₅ each independently represents H or CH₃.

Also, urethane acrylates described in JP-A-51-37193, JP-B-2-32293 and JP-B-2-16765, and urethane compounds having an ethylene oxide skeleton described in JP-B-58-49860, JP-B-56-17654, JP-B-62-39417 and JP-B-62-39418 are preferably used.

Also, as the radical polymerizable compound, compounds described in Paragraph Nos. [0095] to [0108] of JP-A-2009-288705 are preferably used in the invention.

Also, as the radical polymerizable compound, a compound having an ethylenically unsaturated group which contains at least one addition polymerizable ethylene group and has a boiling point of 100° C. or more under normal pressure is also preferred. Examples thereof include a monofunctional acrylate or methacrylate, for example, polyethylene glycol mono(meth)acrylate, polypropylene glycol mono(meth)acrylate or phenoxyethyl (meth)acrylate; a polyfunctional acrylate or methacrylate, for example, polyethylene glycol di(meth)acrylate, trimethylolethane tri(meth)acrylate, neopentyl glycol di(meth)acrylate, pentaerythritol tri(meth)acrylate, pentaerythritol tetra(meth)acrylate, dipentaerythritol penta(meth)acrylate, dipentaerythritol hexa(meth)acrylate, hexanediol (meth)acrylate, trimethylolpropane tri(acryloyloxypropyl)ether, tri(acryloyloxyethyl)isocyanurate, a compound obtained by adding ethylene oxide or propylene oxide to a polyfunctional alcohol, for example, glycerol or trimethylolethane, followed by (meth)acrylation, an urethane (meth)acrylate as described in JP-B-48-41708, JP-B-50-6034 and JP-A-51-37193, a polyester acrylate described in JP-A-48-64183, JP-B-49-43191 and JP-B-52-30490, and an epoxy acrylate as a reaction product of an epoxy resin and (meth)acrylic acid; and a mixture thereof.

A polyfunctional (meth)acrylate obtained by reacting a polyfunctional carboxylic acid with a compound having a cyclic ether group and an ethylenically unsaturated group, for example, glycidyl (meth)acrylate is also exemplified.

Also, as other preferred radical polymerizable compounds, compounds having a fluorene ring and two or more ethylenic polymerizable groups described, for example, in JP-A-2010-160418, JP-A-2010-129825 and Japanese Patent No. 4,364,216, and a cardo resin may also be used.

Further, as other examples of the radical polymerizable compound, specific unsaturated compounds described in JP-B-46-43946, JP-B-1-40337 and JP-B-1-40336, and vinylphosphonic acid compounds described in JP-A-2-25493 can also be exemplified. In some cases, structure containing a perfluoroalkyl group described in JP-A-61-22048 can be preferably used. Moreover, photocurable monomers or oligomers described in Nippon Secchaku Kyokaishi (Journal of Japan Adhesion Society), Vol. 20, No. 7, pages 300 to 308 (1984) can also be used.

As the compound having an ethylenically unsaturated group which contains at least one addition polymerizable ethylene group and has a boiling point of 100° C. or more under normal pressure, compounds described in Paragraph Nos. [0254] to [0257] of JP-A-2008-292970 are also preferred.

In addition, radical polymerizable compounds represented by formulae (MO-1) to (MO-5) shown below can also be preferably used. In the formulae, when T is an oxyalkylene group, the oxyalkylene group is connected to R at its terminal on the carbon atom side.

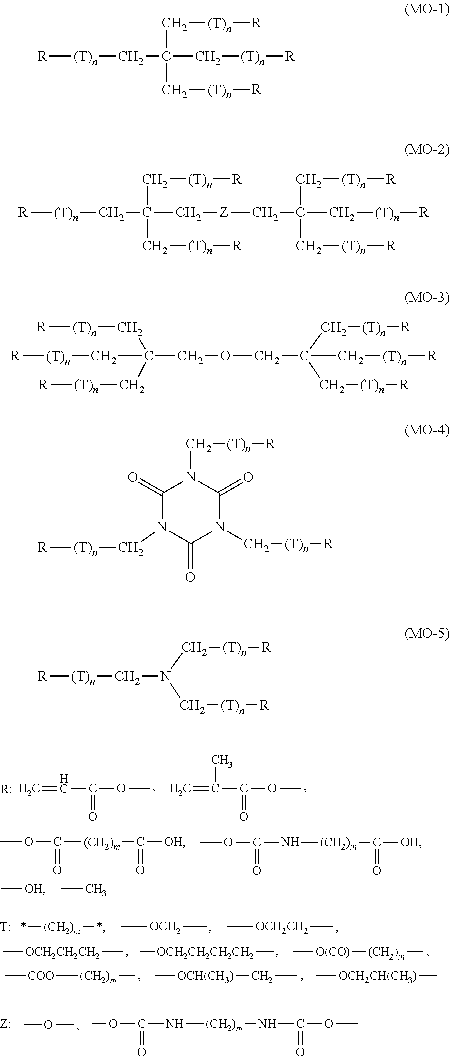

In the formulae above, n is from 0 to 14 and m is from 1 to 8. When plural Rs or plural Ts are present in one molecule, plural Rs or plural Ts may be the same or different from each other.

In each of the radical polymerizable compounds represented by formulae (MO-1) to (MO-5), at least one of plural Rs represents a group represented by —OC(═O)CH═CH₂ or —OC(═O)C(CH₃)═CH₂.

As to specific examples of the radical polymerizable compounds represented by formulae (MO-1) to (MO-5), compounds described in Paragraph Nos. [0248] to [0251] of JP-A-2007-269779 may also be preferably used in the invention.

The compound obtained by adding ethylene oxide or propylene oxide to a polyfunctional alcohol, followed by (meth)acrylation described above, represented by formulae (1) and (2) described together with their specific examples in JP-A-10-62986 can also be used as the radical polymerizable compound.

Among them, dipentaerythritol triacrylate (as a commercially available product, KAYARAD D-330, produced by Nippon Kayaku Co., Ltd.), dipentaerythritol tetraacrylate (as a commercially available product, KAYARAD D-320, produced by Nippon Kayaku Co., Ltd.), dipentaerythritol penta(meth)acrylate (as a commercially available product, KAYARAD D-310, produced by Nippon Kayaku Co., Ltd.), dipentaerythritol hexa(meth)acrylate (as a commercially available product, KAYARAD DPHA, produced by Nippon Kayaku Co., Ltd.), and structures where the (meth)acryloyl group of the compounds described above are connected through an ethylene glycol or propylene glycol residue are preferred as the radical polymerizable compound. Oligomer types of these compounds can also be used.

The radical polymerizable compound may be a polyfunctional monomer having an acid group, for example, a carboxyl group, sulfonic acid group or phosphoric acid group. Therefore, when the ethylenic compound has an unreacted carboxyl group as in the case of the mixture described above, it may be utilized as it is but, if desired, a non-aromatic carboxylic anhydride may be reacted with a hydroxy group of the ethylenic compound to introduce an acid group. In this case, specific examples of the non-aromatic carboxylic anhydride include tetrahydrophthalic anhydride, an alkylated tetrahydrophthalic anhydride, hexahydrophthalic anhydride, an alkylated hexahydrophthalic anhydride, succinic anhydride and maleic anhydride.

In the invention, the acid group-containing monomer is preferably a polyfunctional monomer which is an ester of an aliphatic polyhydroxy compound and an unsaturated carboxylic acid and obtained by reacting a non-aromatic carboxylic anhydride with an unreacted hydroxyl group of the aliphatic polyhydroxy compound to introduce the acid group, and particularly preferably the ester described above where the aliphatic polyhydroxy compound is pentaerythritol and/or dipentaerythritol. The commercially available product thereof includes, for example, polybasic acid-modified acryl oligomers M-510 and M-520 produced by Toagosei Co., Ltd.

The monomers may be used individually, but since it is difficult to use a single compound in view of production, two or more monomers may be used as a mixture. Also, as the monomer, a polyfunctional monomer having no acid group and a polyfunctional monomer having an acid group may be used in combination, if desired.

The acid value of the polyfunctional monomer having an acid group is preferably from 0.1 to 40 mg-KOH/g, and particularly preferably from 5 to 30 mg-KOH/g. When the acid value of the polyfunctional monomer is too low, the development dissolution characteristic decreases, whereas when the acid value of the polyfunctional monomer is too high, the production or handling thereof becomes difficult, the photopolymerization performance decreases and the curing property, for example, surface smoothness of pixel deteriorates. Therefore, in the case where two or more polyfunctional monomers having different acid groups are used in combination or in the case where a polyfunctional monomer having no acid group is used in combination, it is essential to adjust the acid value as the total polyfunctional monomer falls within the range described above.

Also, it is preferred to contain a polyfunctional monomer having a caprolactone structure as the radical polymerizable compound.

The polyfunctional monomer having a caprolactone structure is not particularly limited as long as it has a caprolactone structure in the molecule thereof, and includes, for example, an e-caprolactone-modified polyfunctional (meth)acrylate obtained by esterification of a polyhydric alcohol, for example, trimethylolethane, ditrimethylolethane, trimethylolpropane, ditrimethylolpropane, pentaerythritol, dipentaerythritol, tripentaerythritol, glycerol, diglycerol or trimethylolmelamine with (meth)acrylic acid and 8-caprolactone. Among them, a polyfunctional monomer having a caprolactone structure represented by formula (1) shown below is preferred.

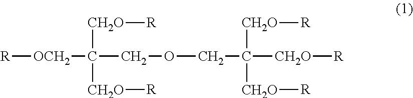

In formula (1), all of six Rs are groups represented by formula (2) shown below, or one to five of six Rs are groups represented by formula (2) shown below and the remainder is a group represented by formula (3) shown below.

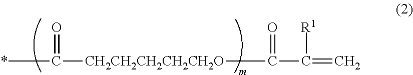

In formula (2), R¹ represents a hydrogen atom or a methyl group, m represents a number of 1 or 2, and * represents a connecting site.

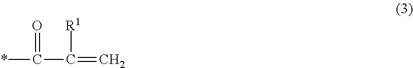

In formula (3), R¹ represents a hydrogen atom or a methyl group and * represents a connecting site.

The polyfunctional monomer having a caprolactone structure is commercially available as KAYARAD DPCA Series from Nippon Kayaku Co., Ltd. and includes DPCA-20 (compound represented by formulae (1) to (3), wherein m is 1, a number of the groups represented by formula (2) is 2, and all of R¹ are hydrogen atoms), DPCA-30 (compound represented by formulae (1) to (3), wherein m is 1, a number of the groups represented by formula (2) is 3, and all of R¹ are hydrogen atoms), DPCA-60 (compound represented by formulae (1) to (3), wherein m is 1, a number of the groups represented by formula (2) is 6, and all of R¹ are hydrogen atoms) and DPCA-120 (compound represented by formulae (1) to (3), wherein m is 2, a number of the groups represented by formula (2) is 6, and all of R¹ are hydrogen atoms).

The polyfunctional monomers having a caprolactone structure may be used individually or as a mixture of two or more thereof in the invention.

It is also preferred that the polyfunctional monomer is at least one compound selected from the group consisting of compounds represented by formulae (i) and (ii) shown below.

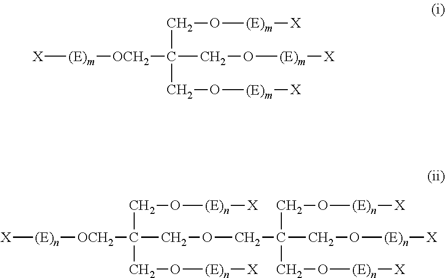

In formulae (i) and (ii), E each independently represents —((CH₂)_{y}CH₂O)— or —((CH₂)_{y}CH(CH₃)O)—, y each independently represents an integer from 0 to 10, and X each independently represents an acryloyl group, a methacryloyl group, a hydrogen atom or a carboxyl group.

In formula (i), the total number of acryloyl groups and methacryloyl groups is 3 or 4, m each independently represents an integer from 0 to 10, and the total of each m is an integer from 0 to 40, provided that when the total of each m is 0, any one of Xs is a carboxyl group.

In formula (ii), the total number of acryloyl groups and methacryloyl group is 5 or 6, n each independently represents an integer from 0 to 10, and the total of each n is an integer from 0 to 60, provided that when the total of each n is 0, any one of Xs is a carboxyl group.

In formula (i), m is preferably an integer from 0 to 6, and more preferably an integer from 0 to 4.

The total of each m is preferably an integer from 2 to 40, more preferably an integer from 2 to 16, and particularly preferably an integer from 4 to 8.

In formula (ii), n is preferably an integer from 0 to 6, and more preferably an integer from 0 to 4.

The total of each n is preferably an integer from 3 to 60, more preferably an integer from 3 to 24, and particularly preferably an integer from 6 to 12.

In a preferred embodiment, —((CH₂)_{y}CH₂O)— or —((CH₂)_{y}CH(CH₃)O)— in formula (i) or (ii) is connected to X at its terminal on the oxygen atom side.

The compounds represented by formulae (i) and (ii) may be used individually or in combination of two or more thereof. In particular, an embodiment where all of six Xs in formula (ii) are acryloyl groups is preferred.

The total content of the compound represented by formula (i) or (ii) in the radical polymerizable compound is preferably 20% by weight or more, and more preferably 50% by weight or more.

The compound represented by formula (i) or (ii) can be synthesized through a process of connecting a ring-opened skeleton of ethylene oxide or propylene oxide to pentaerythritol or dipentaerythritol by a ring-opening addition reaction, and a process of introducing a (meth)acryloyl group into the terminal hydroxyl group of the ring-opened skeleton by reacting, for example, (meth)acryloyl chloride, which are conventionally known processes. Each of the processes is a well-known process, and the compound represented by formula (i) or (ii) can be easily synthesized by a person skilled in the art.

Of the compounds represented by formulae (i) and (ii), a pentaerythritol derivative and/or a dipentaerythritol derivative are more preferred.

Specific examples of the compounds include compounds represented by formulae (a) to (f) shown below (hereinafter, also referred to as Compounds (a) to (f) sometimes), and among them Compounds (a), (b), (e) and (f) are preferred.

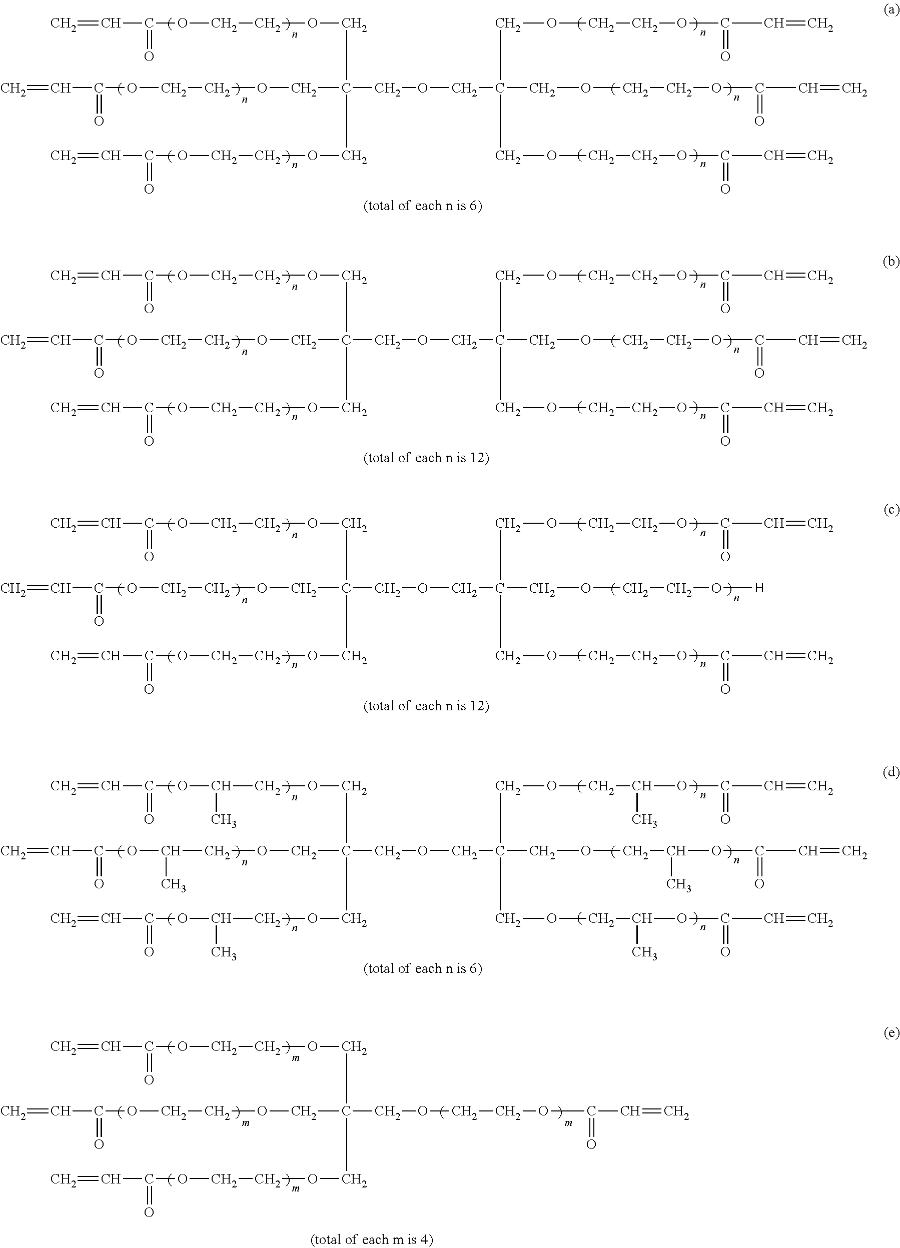

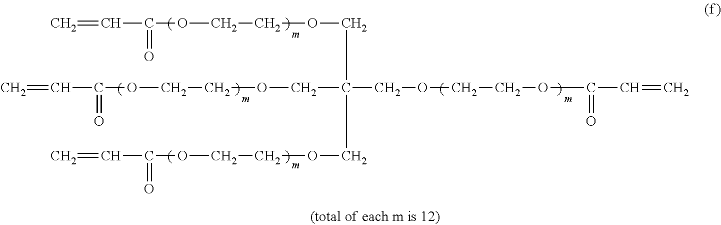

As a commercially available product of the radical polymerizable compound represented by formula (i) or (ii), for example, SR-494 which is a tetrafunctional acrylate having four ethyleneoxy chains, produced by Sartomer Co., and DPCA-60 which is a hexafunctional acrylate having six pentyleneoxy chains and TPA-330 which is a trifunctional acrylate having three isobutyleneoxy chains, produced by Nippon Kayaku Co., Ltd. are exemplified.

Further, urethane acrylates as described in JP-B-48-41708, JP-A-51-37193, JP-B-2-32293 and JP-B-2-16765, and urethane compounds having an ethylene oxide skeleton described in JP-B-58-49860, JP-B-56-17654, JP-B-62-39417 and JP-B-62-39418 are also preferred as the radical polymerizable compound. In addition, addition polymerizable compounds having an amino structure or a sulfide structure in the molecules thereof described in JP-A-63-277653, JP-A-63-260909 and JP-A-1-105238 are also used as the radical polymerizable monomer.

As a commercially available product of the radical polymerizable compound, for example, Urethane Oligomer UAS-10 and UAB-140 (produced by Sanyo-Kokusaku Pulp Co., Ltd.), UA-7200 (produced by Shin-Nakamura Chemical Co., Ltd.), DPHA-40H (produced by Nippon Kayaku Co., Ltd.), and UA-306H, UA-306T, UA-306I, AH-600, T-600 and AI-600 (produced by Kyoeisha Chemical Co., Ltd.) are exemplified.

A polyfunctional thiol compound having two or more mercapto (SH) groups in its molecule is also preferably used as the radical polymerizable compound. In particular, compounds represented by formulae (I) shown below are preferred.

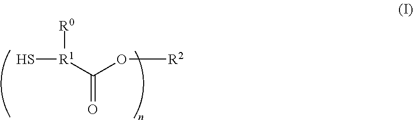

In formula (I), R¹ represents an alkylene group, R² represents an n-valent aliphatic group which may contain an atom(s) other than carbon atom, R⁰ represents an alkyl group exclusive of a hydrogen atom, and n represents an integer from 2 to 4.

Specific examples of the polyfunctional thiol compound represented by formula (I) include 1,4-bis(3-mercaptobutyryloxy)butane (represented by formula (II)), 1,3,5-tris(3-mercaptobutyloxyemyl)-1,3,5-triazine-2,4,6(1H,3H,5H)trione (represented by formula (III)) and pentaerythritol tetrakis(3-mercaptobutylate) (represented by formula (IV)). The polyfunctional thiol compounds may be used individually or in combination of two or more thereof.

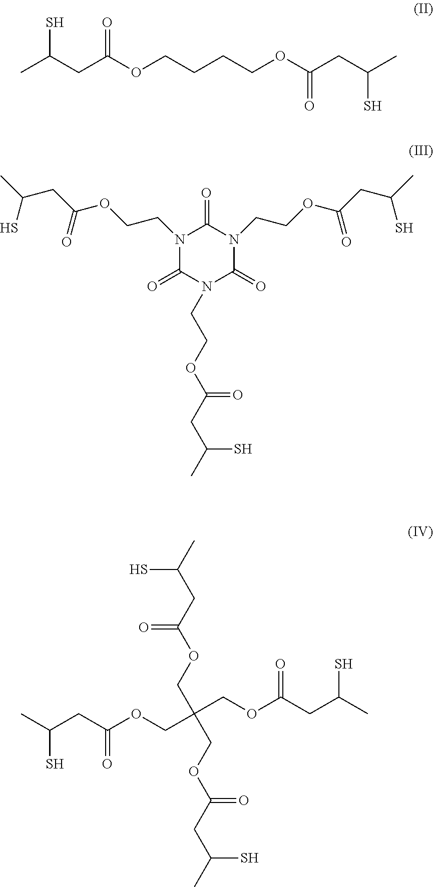

The amount of the polyfunctional thiol compound added to the adhesive composition is preferably in a range from 0.3 to 8.9% by weight, more preferably in a range from 0.8 to 6.4% by weight, based on the total solid content exclusive of the solvent. By the addition of polyfunctional thiol compound, stability, odor, sensitivity, adhesion property and the like of the adhesive composition can be improved.

Details of the method of using the radical polymerizable compound, for example, selection of the structure, individual or combination use, or an amount added, can be appropriately set depending on the final characteristic design of the adhesive composition. For instance, from the standpoint of the sensitivity (efficiency of decrease in the adhesion property due to the irradiation of active light or radiation), a structure having a large content of unsaturated groups per molecule is preferred, and in many cases, a difunctional or more functional compound is preferred. In order to increase the strength of adhesive layer, a trifunctional or more functional compound is preferred. A combination use of compounds different in the functional number or in the kind of polymerizable group (for example, an acrylic acid ester, a methacrylic acid ester, a styrene compound or a vinyl ether compound) is an effective method for controlling both the sensitivity and the strength. Further, a combination use of the radical polymerizable compounds of trifunctional or more functional compounds different in the length of ethylene oxide chain is also preferred. The selection and use method of the radical polymerizable compound are also important factors for the compatibility and dispersibility with other components (for example, a binder or a polymerization initiator) contained in the adhesive composition. For instance, the compatibility may be improved in some cases by using the radical polymerizable compound of low purity or using two or more kinds of the radical polymerizable compounds in combination. A specific structure may be selected for the purpose of improving the adhesion property to a carrier substrate.

The ionic polymerizable compound (B2) includes, for example, an epoxy compound having from 3 to 20 carbon atoms (B21) and an oxetane compound having from 4 to 20 carbon atoms (B22).

The epoxy compound having from 3 to 20 carbon atoms (B21) includes, for example, monofunctional and multifunctional epoxy compounds described below.

The monofunctional epoxy compound includes, for example, phenyl glycidyl ether, p-tert-butylphenyl glycidyl ether, butyl glycidyl ether, 2-ethylhexyl glycidyl ether, allyl glycidyl ether, 1,2-butylene oxide, 1,3-butadiene monoxide, 1,2-epoxydodecane, epichlorohydrin, 1,2-epoxydecane, styrene oxide, cyclohexene oxide, 3-methacryloyloxymethylcyclohexene oxide, 3-acryloyloxymethylcyclohexene oxide and 3-vinylcyclohexene oxide.

The multifunctional epoxy compound includes, for example, bisphenol A diglycidyl ether, bisphenol F diglycidyl ether, bisphenol S diglycidyl ether, brominated bisphenol A diglycidyl ether, brominated bisphenol F diglycidyl ether, brominated bisphenol S diglycidyl ether, epoxy novolac resin, hydrogenated bisphenol A diglycidyl ether, hydrogenated bisphenol F diglycidyl ether, hydrogenated bisphenol S diglycidyl ether, 3,4-epoxycyclohexylmethyl-3′,4′-epoxycyclohexanecarboxylate, 2-(3,4-epoxycyclohexyl-5,5-spiro-3,4-epoxy)cyclohexane-meta-dioxane, bis(3,4-epoxycyclohexylmethyl) adipate, vinylcyclohexene oxide, 4-vinyl epoxycyclohexane, bis(3,4-epoxy-6-methylcyclohexylmethyl) adipate, 3,4-epoxy-6-methylcyclohexyl-3′,4′-epoxy-6′-methylcyclohexane carboxylate, methylenebis(3,4-epoxycyclohexane), dicyclopentadiene diepoxide, ethylene glycol di(3,4-epoxycyclohexylmethyl) ether, ethylene bis(3,4-epoxycyclohexane carboxylate), dioctyl epoxy hexahydrophthalate, di-2-ethylhexyl epoxyhexahydrophthalate, 1,4-butanediol diglycidyl ether, 1,6-hexanediol diglycidyl ether, glycerol triglycidyl ether, trimethylolpropane triglycidyl ether, polyethylene glycol diglycidyl ether, polypropylene glycol diglycidyl ether, 1,1,3-tetradecadiene dioxide, limonene dioxide, 1,2,7,8-diepoxyoctane and 1,2,5,6-diepoxycyclooctane.

Of the epoxy compounds, from the standpoint of excellent polymerization speed, an aromatic epoxide and an alicyclic epoxide are preferred, and an alicyclic epoxide is particularly preferred.

The oxetane compound having from 4 to 20 carbon atoms (B22) includes, for example, compounds having from 1 to 6 oxetane rings.

The compound having one oxetane ring includes, for example, 3-ethyl-3-hydroxymethyl oxetane, 3-(meth)allyloxymethyl-3-ethyl oxetane, (3-ethyl-3-oxetanylmethoxy)methylbenzene, 4-fluoro-[1-(3-ethyl-3-oxetanylmethoxy)methyl]benzene, 4-methoxy[1-(3-ethyl-3-oxetanylmethoxy)methyl]benzene, [1-(3-ethyl-3-oxetanylmethoxy)ethyl]phenyl ether, isobutoxymethyl(3-ethyl-3-oxetanylmethyl) ether, isobornyloxyethyl(3-ethyl-3-oxetanylmethyl) ether, isobornyl(3-ethyl-3-oxetanylmethyl) ether, 2-ethylhexyl(3-ethyl-3-oxetanylmethyl) ether, ethyldiethylene glycol(3-ethyl-3-oxetanylmethyl) ether, dicyclopentadiene(3-ethyl-3-oxetanylmethyl) ether, dicyclopentenyloxyethyl(3-ethyl-3-oxetanylmethyl) ether, dicyclopentenyl(3-ethyl-3-oxetanylmethyl) ether, tetrahydrofurfuryl(3-ethyl-3-oxetanylmethyl) ether, tetrabromophenyl(3-ethyl-3-oxetanylmethyl) ether, 2-tetrabromophenoxyethyl(3-ethyl-3-oxetanylmethyl) ether, tribromophenyl(3-ethyl-3-oxetanylmethyl) ether, 2-tribromophenoxyethyl(3-ethyl-3-oxetanylmethyl) ether, 2-hydroxyethyl(3-ethyl-3-oxetanylmethyl) ether, 2-hydroxypropyl(3-ethyl-3-oxetanylmethyl) ether, butoxyethyl(3-ethyl-3-oxetanylmethyl) ether, pentachlorophenyl(3-ethyl-3-oxetanylmethyl) ether, pentabromophenyl(3-ethyl-3-oxetanylmethyl) ether and bornyl(3-ethyl-3-oxetanylmethyl) ether.

The compound having from 2 to 6 oxetane rings includes, for example, 3,7-bis(3-oxetanyl)-5-oxanonane, 3,3′-(1,3-(2-methylenyl)propanediylbis(oxymethylene))bis(3-ethyloxetane), 1,4-bis[(3-ethyl-3-oxetanylmethoxy)methyl]benzene, 1,2-bis[(3-ethyl-3-oxetanylmethoxy)methyl]ethane, 1,3-bis[(3-ethyl-3-oxetanylmethoxy)methyl]propane, ethylene glycol bis(3-ethyl-3-oxetanylmethyl) ether, dicyclopentenyl bis(3-ethyl-3-oxetanylmethyl) ether, triethylene glycol bis(3-ethyl-3-oxetanylmethyl) ether, tetraethylene glycol bis(3-ethyl-3-oxetanylmethyl) ether, tricyclodecanediyldimethylene (3-ethyl-3-oxetanylmethyl) ether, trimethylol propane tris(3-ethyl-3-oxetanylmethyl) ether, 1,4-bis(3-ethyl-3-oxetanylmethoxy)butane, 1,6-bis(3-ethyl-3-oxetanylmethoxy)hexane, pentaerythritol tris(3-ethyl-3-oxetanylmethyl) ether, pentaerythritol tetrakis(3-ethyl-3-oxetanylmethyl) ether, polyethylene glycol bis(3-ethyl-3-oxetanylmethyl) ether, dipentaerythritol hexakis(3-ethyl-3-oxetanylmethyl) ether, dipentaerythritol pentakis(3-ethyl-3-oxetanylmethyl) ether, dipentaerythritol tetrakis(3-ethyl-3-oxetanylmethyl) ether, caprolactone-modified dipentaerythritol hexakis(3-ethyl-3-oxetanylmethyl) ether, caprolactone-modified dipentaerythritol pentakis(3-ethyl-3-oxetanylmethyl) ether, ditrimethylolpropane tetrakis(3-ethyl-3-oxetanylmethyl) ether, EO-modified bisphenol A bis(3-ethyl-3-oxetanylmethyl) ether, PO-modified bisphenol A bis(3-ethyl-3-oxetanylmethyl) ether, EO-modified hydrogenated bisphenol A bis(3-ethyl-3-oxetanylmethyl) ether, PO-modified hydrogenated bisphenol A bis(3-ethyl-3-oxetanylmethyl) ether and EO-modified bisphenol F (3-ethyl-3-oxetanylmethyl) ether.

The content of the polymerizable monomer is preferably from 5 to 80% by weight, more preferably from 10 to 75% by weight, still more preferably from 10 to 70% by weight, based on the total solid content of the adhesive layer from the standpoint of good adhesion strength and good releasing property.

Also, a ratio (weight ratio) of contents of the polymerizable monomer and the binder is preferably from 90/10 to 10/90, and more preferably from 20/80 to 80/20.

As the solvent, known solvents can be used without limitation as long as it can form the adhesive layer. For example, methyl amyl ketone, N-methyl-2-pyrrolidone, propylene glycol monomethyl ether acetate (PGMEA), tetrahydrofuran (THF), limonene, cyclohexanone and γ-butyrolactone are used, and methyl amyl ketone, N-methyl-2-pyrrolidone or PGMEA is preferred.

The solvent is preferably used so that the solid content concentration of the adhesive composition becomes from 5 to 40% by weight.

The adhesive composition (therefore the adhesive layer) preferably contains a photopolymerization initiator, that is, a compound which generates a radical or an acid by irradiation of active light or radiation.

By incorporating the photopolymerization initiator, when the adhesive layer is irradiated with light, curing of the adhesive composition occurs by a radical or an acid to reduce the adhesion property in the light-irradiated area. When the irradiation is conducted, for example, in the central area of the adhesive layer, whereby the adhesion property remains only in the peripheral area, an advantage is obtained in that the time necessary for the release is shortened because the area of the adhesive layer to be dissolved by solvent immersion at the time of release becomes small.

As the compound which generates a radical or an acid by irradiation of active light or radiation, for example, compounds known as photopolymerization initiators described below can be used.

The photopolymerization initiator is not particularly limited as long as it has an ability to initiate a polymerization reaction (crosslinking reaction) of a reactive compound having a polymerizable group as the polymerizable monomer, and can be appropriately selected from known photopolymerization initiators. For example, a photopolymerization initiator having photosensitivity to light from an ultraviolet region to a visible region is preferred. Also, the photopolymerization initiator may be an activator which causes any action with a photo-excited sensitizer to produce an active radical, or depending on the kind of monomer it may be an initiator which generates an acid to initiate cation polymerization.

Further, it is preferred that the photopolymerization initiator contains at least one compound having a molecular absorption coefficient of at least about 50 in the range from about 300 to 800 nm (preferably from 330 to 500 nm).

As the photopolymerization initiator, known compounds are used without limitation. The photo-radical polymerization initiator includes, for example, a halogenated hydrocarbon derivative (for example, a compound having a triazine skeleton, a compound having an oxadiazole skeleton or a compound having a trihalomethyl group), an acylphosphine compound, for example, an acylphosphine oxide, a hexaarylbiimidazole, an oxime compound, for example, an oxime derivative, an organic peroxide, a thio compound, a ketone compound, an aromatic onium salt, a ketoxime ether, an aminoacetophenone compound, a hydroxyacetophenone, an azo compound, an azide compound, a metallocene compound, an organic boron compound, and an iron arene complex.

The halogenated hydrocarbon compound having a triazine skeleton includes, for example, compounds described in Wakabayashi et al., Bull. Chem. Soc. Japan, 42, 2924 (1969), compounds described in British Patent 1,388,492, compounds described in JP-A-53-133428, compounds described in German Patent 3,337,024, compounds described in F. C. Schaefer et al., J. Org. Chem., 29, 1527 (1964), compounds described in JP-A-62-58241, compounds described in JP-A-5-281728, compounds described in JP-A-5-34920, and compounds described in U.S. Pat. No. 4,212,976.

The compounds described in U.S. Pat. No. 4,212,976 include, for example, a compound having an oxadiazole skeleton (for example, 2-trichloromethyl-5-phenyl-1,3,4-oxadiazole, 2-trichloromethyl-5-(4-chlorophenyl)-1,3,4-oxadiazole, 2-trichloromethyl-5-(1-naphthyl)-1,3,4-oxadiazole, 2-trichloromethyl-5-(2-naphthyl)-1,3,4-oxadiazole, 2-tribromomethyl-5-phenyl-1,3,4-oxadiazole, 2-tribromomethyl-5-(2-naphthyl)-1,3,4-oxadiazole, 2-trichloromethyl-5-styryl-1,3,4-oxadiazole, 2-trichloromethyl-5-(4-chlorostyryl)-1,3,4-oxadiazole, 2-trichloromethyl-5-(4-methoxystyryl)-1,3,4-oxadiazole, 2-trichloromethyl-5-(1-naphthyl)-1,3,4-oxadiazole, 2-trichloromethyl-5-(4-n-buthoxystyryl)-1,3,4-oxadiazole or 2-tribromomethyl-5-styryl-1,3,4-oxadiazole).

Also, examples of the photopolymerization initiator other than the polymerization initiators described above include an acridine derivative (for example, 9-phenylacridine or 1,7-bis(9,9′-acridinyl)heptane), N-phenylglycine, a polyhalogen compound (for example, carbon tetrabromide, phenyl tribromomethyl sulfone or phenyl trichloromethyl ketone), a coumarin (for example, 3-(2-benzofuranoyl)-7-diethylaminocoumarin, 3-(2-benzofuroyl)-7-(1-pyrrolidinyl)coumarin, 3-benzoyl-7-diethylaminocoumarin, 3-(2-methoxybenzoyl)-7-diethylaminocoumarin, 3-(4-dimethylaminobenzoyl)-7-diethylaminocoumarin, 3,3′-carbonylbis(5,7-di-n-propoxycoumarin), 3,3′-carbonylbis(7-diethylaminocoumarin), 3-benzoyl-7-methoxycoumarin, 3-(2-furoyl)-7-diethylaminocoumarin, 3-(4-diethylaminocinnamoyl)-7-diethylaminocoumarin, 7-methoxy-3-(3-pyridylcarbonyl)coumarin, 3-benzoyl-5,7-dipropoxycoumarin, 7-benzotriazol-2-ylcoumarin, coumarin compounds described, for example, in JP-A-5-19475, JP-A-7-271028, JP-A-2002-363206, JP-A-2002-363207, JP-A-2002-363208 and JP-A-2002-363209), an acylphosphine oxide (for example, bis(2,4,6-trimethylbenzoyl)phenylphosphine oxide, bis(2,6-dimethoxybenzoyl)-2,4,4-trimethylpentylphenylphosphine oxide or LUCIRIN TPO), a metallocene (for example, bis(η5-2,4-cyclopentadien-1-yl)-bis(2,6-difluoro-3-(1H-pyrrol-1-yl)phenyl)titanium or η5-cyclopentadienyl-η6-cumenyl-iron(1+)-hexafluorophosphate(1−)), compounds described in JP-A-53-133428, JP-B-57-1819, JP-B-57-6096 and U.S. Pat. No. 3,615,455.

The ketone compound includes, for example, benzophenone, 2-methylbenzophenone, 3-methylbenzophenone, 4-methylbenzophenone, 4-methoxybenzophenone, 2-chlorobenzophenone, 4-chlorobenzophenone, 4-bromobenzophenone, 2-carboxybenzophenone, 2-ethoxycarbonylbenzophenone, benzophenone tetracarboxylic acid or tetramethyl ester thereof, a 4,4′-bis(dialkylamino)benzophenone (for example, 4,4′-bis(dimethylamino)benzophenone, 4,4′-bis(dicyclohexylamino)benzophenone, 4,4′-bis(diethylamino)benzophenone or 4,4′-bis(dihydroxyethylamino)benzophenone), 4-methoxy-4′-dimethylaminobenzophenone, 4,4′-dimethoxybenzophenone, 4-dimethylaminobenzophenone, 4-dimethylaminoacetophenone, benzyl, anthraquinone, 2-tert-butylanthraquinone, 2-methylanthraquinone, phenanthraquinone, xanthone, thioxanthone, 2-chlorothioxanthone, 2,4-diethylthioxanthone, fluorenone, 2-benzyldimethylamino-1-(4-morpholinophenyl)-1-butanone, 2-methyl-1-[4-(methylthio)phenyl]-2-morpholino-1-propanone, 2-hydroxy-2-methyl-[4-(1-methylvinyl)phenyl]propanol oligomer, benzoin, a benzoin ether (for example, benzoin methyl ether, benzoin ethyl ether, benzoin propyl ether, benzoin isopropyl ether, benzoin phenyl ether or benzyl dimethyl ketal), acridone, chloroacridone, N-methylacridone, N-butylacridone and N-butylchloroacridone.

As the photopolymerization initiator, a hydroxyacetophenone compound, an aminoacetophenone compound and an acylphosphine compound can also be preferably used. More specifically, for example, an aminoacetophenone initiator described in JP-A-10-291969 and an acylphosphine oxide initiator described in Japanese Patent No. 4225898 can also be used.

As the hydroxyacetophenone initiator, IRGACURE 184, DAROCUR 1173, IRGACURE 500, IRGACURE 2959 and IRGACURE 127 (trade names, produced by BASF Corp.) can be used. As the aminoacetophenone initiator, commercially available products of IRGACURE 907, IRGACURE 369 and IRGACURE 379 (trade names, produced by BASF Corp.) can be used. As the aminoacetophenone initiator, compounds described in JP-A-2009-191179, where the absorption wavelength matches the light source having a long wavelength, for example, 365 nm or 405 nm, can also be used. Also, as the acylphosphine initiator, commercially available products of IRGACURE 819 and DAROCUR TPO (trade names, produced by BASF Corp.) can be used.

The photopolymerization initiator more preferably includes an oxime compound. As specific examples of the oxime initiator, compounds described in JP-A-2001-233842, compounds describe in JP-A-2000-80068 and compounds described in JP-A-2006-342166 can be used.

Examples of the oxime compound, for example, an oxime derivative, which is preferably used as the photopolymerization initiator in the invention include 3-benzoyloxyiminobutan-2-one, 3-acetoxyiminobutan-2-one, 3-propionyloxyiminobutan-2-one, 2-acetoxyiminopentan-3-one, 2-acetoxyimino-1-phenylpropan-1-one, 2-benzoyloxyimino-1-phenylpropan-1-one, 3-(4-toluenesulfonyloxyl)iminobutan-2-one and 2-ethoxycarbonyloxyimino-1-phenylpropan-1-one.

The oxime ester compound includes, for example, compounds described in J. C. S. Perkin II, (1979) pp. 1653-1660, J. C. S. Perkin II, (1979) pp. 156-162, Journal of Photopolymer Science and Technology, (1995) pp 202-232, JP-A-2000-66385, JP-A-2000-80068, JP-T-2004-534797 and JP-A-2006-342166.

As the commercially available product, IRGACURE OXE 01 (produced by BASF Corp.) and IRGACURE OXE 02 (produced by BASF Corp.) are also preferably used.

In addition, as the oxime ester compound other than the oxime ester compounds described above, compounds described in JP-T-2009-519904, wherein oxime is connected to the N-position of carbazole, compounds described in U.S. Pat. No. 7,626,957, wherein a hetero-substituent is introduced into the benzophenone moiety, compounds described in JP-A-2010-15025 and U.S. Patent Publication No. 2009/0292039, wherein a nitro group is introduced into the dye moiety, ketoxime compounds described in WO 2009/131189, compounds containing a triazine skeleton and an oxime skeleton in the same molecule described in U.S. Pat. No. 7,556,910, and compounds having an absorption maximum at 405 nm and exhibiting good sensitivity for a g-line light source described in JP-A-2009-221114 may also be used.

Furthermore, cyclic oxime compounds described in JP-A-2007-231000 and JP-A-2007-322744 can also be preferably used. Of the cyclic oxime compounds, cyclic oxime compounds condensed to a carbazole dye described in JP-A-2010-32985 and JP-A-2010-185072 have high light absorptivity and thus are preferred from the standpoint of high sensitivity.

Further, compounds described in JP-A-2009-242469 having an unsaturated bond at a specific site of an oxime compound can achieve high sensitivity by regenerating an active radical from a polymerization inactive radical, and thus are preferably used.

Oxime compounds having a specific substituent described in JP-A-2007-269779 and oxime compounds having a thioaryl group described in JP-A-2009-191061 are most preferred.

The molar absorption coefficient of the compound can be measured by using a known method, and specifically, it is preferred that the molar absorption coefficient is measured, for example, by an ultraviolet and visible spectrophotometer (Carry-5 spectrophotometer, produced by Varian, Inc.) using an ethyl acetate solvent at a concentration of 0.01 g/L.

The polymerization initiators used in the invention may be used two or more thereof in combination, if desired.

From the standpoint of exposure sensitivity, the compound which generates a radical or an acid by irradiation of active light or radiation is preferably a compound selected from the group consisting of a trihalomethyltriazine compound, a benzyl dimethyl ketal compound, an α-hydroxyketone compound, an α-aminoketone compound, an acyl phosphine compound, a phosphine oxide compound, a metallocene compound, an oxime compound, a triallylimidazole dimer, an onium compound, a benzothiazole compound, a benzophenone compound, an acetophenone compound and a derivative thereof, a cyclopentadiene-benzene-iron complex and a salt thereof, a halomethyloxadiazole compound and a 3-aryl-substituted coumarin compound.

A trihalomethyltriazine compound, an α-aminoketone compound, an acyl phosphine compound, a phosphine oxide compound, an oxime compound, a triallylimidazole dimer, an onium compound, a benzophenone compound or an acetophenone compound is more preferred, and at least one compound selected from the group consisting of a trihalomethyltriazine compound, an α-aminoketone compound, an oxime compound, a triallylimidazole dimer and a benzophenone compound is most preferred. It is most preferred to use an oxime compound.

Of the compounds which generate a radical or an acid by irradiation of active light or radiation, a compound which generates an acid having pKa of 4 or less is preferred, and a compound which generates an acid having pKa of 3 or less is more preferred.

Examples of the compound which generates an acid include a trichloromethyl-s-triazine, a sulfonium salt, an iodonium salt, a quaternary ammonium salt, a diazomethane compound, an imidosulfonate compound and an oximesulfonate compound. Of the compounds, from the standpoint of high sensitivity, an oximesulfonate compound is preferably used. The acid generating agents may be used individually or in combination of two or more thereof.

The acid generating agent specifically includes, acid generating agents described in Paragraph Nos. [0073] to [0095] of JP-A-2012-8223.

The content of the compound which generates a radical or an acid by irradiation of active light or radiation (D) according to the invention (total content in the case of using two or more compounds) is preferably from 0.1 to 50% by weight, more preferably from 0.1 to 30% by weight, still more preferably from 0.1 to 20% by weight, based on the total solid content of the adhesive layer.

It is also preferred that the adhesive composition (therefore the adhesive layer) contains a heat polymerization initiator, that is, a compound which generates a radical or an acid by heat.

In particular, in the case where the adhesive composition contains a polymer compound having a polymerizable group as the binder or the polymerizable monomer, the adhesive composition preferably contains the heat polymerization initiator.

The presence of the heat polymerization initiator has an advantage in that by heating to a temperature higher than the decomposition temperature of the heat polymerization initiator after bonding the adhesive layer and the release layer, the adhesive layer is cured, whereby the adhesion of high heat resistance and chemical resistance can be achieved.

[Compound which Generates Radical by Heat]

As the compound which generates a radical by heat (hereinafter, also simply referred to as a heat radical generating agent), known heat radical generating agents can be used.

The heat radical generating agent generates a radical by energy of heat and initiates or accelerates the polymerization reaction of the polymer compound having a polymerizable group and the polymerizable monomer. By adding the heat radical generating agent, in the case where after irradiating heat to the adhesive layer formed by using the temporary adhesive, the temporary adhesion of the member to be processed and the adhesive support is performed, the crosslinking reaction in the reactive compound having a crosslinkable group proceeds by the heat so that the adhesion property (that is, adherence property and tacking property) of the adhesive layer can be previously reduced as described in detail below.

On the other hand, in the case where after performing the temporary adhesion of the member to be processed and the adhesive support, heat is irradiated to the adhesive layer of the adhesive support, the crosslinking reaction in the reactive compound having a crosslinkable group proceeds by the heat so that the adhesive layer becomes more tough to prevent cohesion failure of the adhesive layer, which may likely occur, for example, when the member to be processed is subjected to a mechanical or chemical processing. Specifically, the adhesion property of the adhesive layer can be increased.

As a preferred heat radical generating agent, the compound which generates a radical or an acid by irradiation of active light or radiation is exemplified, and a compound having a heat decomposition point ranging from 130 to 250° C., preferably from 150 to 220° C., is preferably used.

Examples of the heat radical generating agent include an aromatic ketone, an onium salt compound, an organic peroxide, a thio compound, a hexaarylbiimidazole compound, a ketoxime ester compound, a borate compound, an azinium compound, a metallocene compound, an active ester compound, a compound having a carbon-halogen bond and an azo compound. Among them, an organic peroxide and an azo compound are more preferred, and an organic peroxide is particularly preferred.

Specifically, compounds described in Paragraph Nos. [0074] to [0118] of JP-A-2008-63554 are exemplified.

[Compound which Generates Acid by Heat]

As the compound which generates an acid by heat (hereinafter, also simply referred to as a heat acid generating agent), known heat acid generating agents can be used.

The heat acid generating agent is preferably a compound having a heat decomposition point ranging from 130 to 250° C., and more preferably from 150 to 220° C.

The heat acid generating agent includes, for example, a compound which generates an acid of low nucleophilicity, for example, a sulfonic acid, a carboxylic acid or a disulfonyl imide).

An acid generated from the heat acid generating agent includes preferably a sulfonic acid, an alkyl or aryl carboxylic acid substituted with an electron-withdrawing group and a disulfonyl imide substituted with an electron-withdrawing group, each of which has strong pKa of 2 or less. Examples of the electron-withdrawing group include a halogen atom, for example, a fluorine atom, a haloalkyl group, for example, a trifluoromethyl group, a nitro group and a cyano group.

As the heat acid generating agent, the photo acid generating agent which generates an acid by irradiation of active light or radiation described above can be applied. For instance, an onium salt, for example, a sulfonium salt or an iodonium salt, an N-hydroxyimidosulfonate compound, an oxime sulfonate and an o-nitrobenzyl sulfonate are exemplified.

In the invention, it is also preferred to use a sulfonic acid ester which substantially does not generate an acid by the irradiation of active light or radiation but generates an acid by heat.

To not substantially generate an acid by the irradiation of active light or radiation can be judged by measuring an infrared absorption (IR) spectrum or a nuclear magnetic resonance (NMR) spectrum before and after exposure of the compound and confirming that there is no change in the spectrum.

The molecular weight of the sulfonic acid ester is preferably from 230 to 1,000, and more preferably from 230 to 800.

The sulfonic acid ester which can be used in the invention may be a commercially available product or a sulfonic acid ester synthesized by a known method. The sulfonic acid ester can be synthesized, for example, by reacting a sulfonyl chloride or a sulfonic anhydride with a corresponding polyhydric alcohol under a basic condition.

The heat acid generating agents may be used individually or in combination of two or more thereof.

The content of the heat polymerization initiator in the adhesive composition is preferably from 0.01 to 50% by weight, more preferably from 0.1 to 20% by weight, most preferably from 0.5 to 10% by weight, based on the total solid content of the adhesive composition, from the standpoint of reducing the adhesion property of the adhesive layer in the case of conducting the irradiation of heat before performing the temporary adhesion of the member to be processed and the adhesive support and increasing the adhesion property of the adhesive layer in the case of conducting the irradiation of heat after performing the temporary adhesion of the member to be processed and the adhesive support.

### <Other Components>

The adhesive composition (therefore the adhesive layer) can contain various compounds, if desired, in addition to the components described above as long as the effects of the invention are not impaired. For example, a sensitizing dye, a chain transfer agent, a polymerization inhibitor or a surfactant can be preferably used.

Specific examples and preferred examples of the surfactant which the adhesive composition (therefore the adhesive layer) may contain are same as those of the surfactant which the release layer composition may contain described above.

The adhesive composition (therefore the adhesive layer) preferably contains the binder, the polymerizable monomer, and at least one of the photopolymerization initiator and the heat polymerization initiator.

Next, the adhesive support and production method of semiconductor device using the temporary bonding layer for production of semiconductor device according to the invention described above will be described.

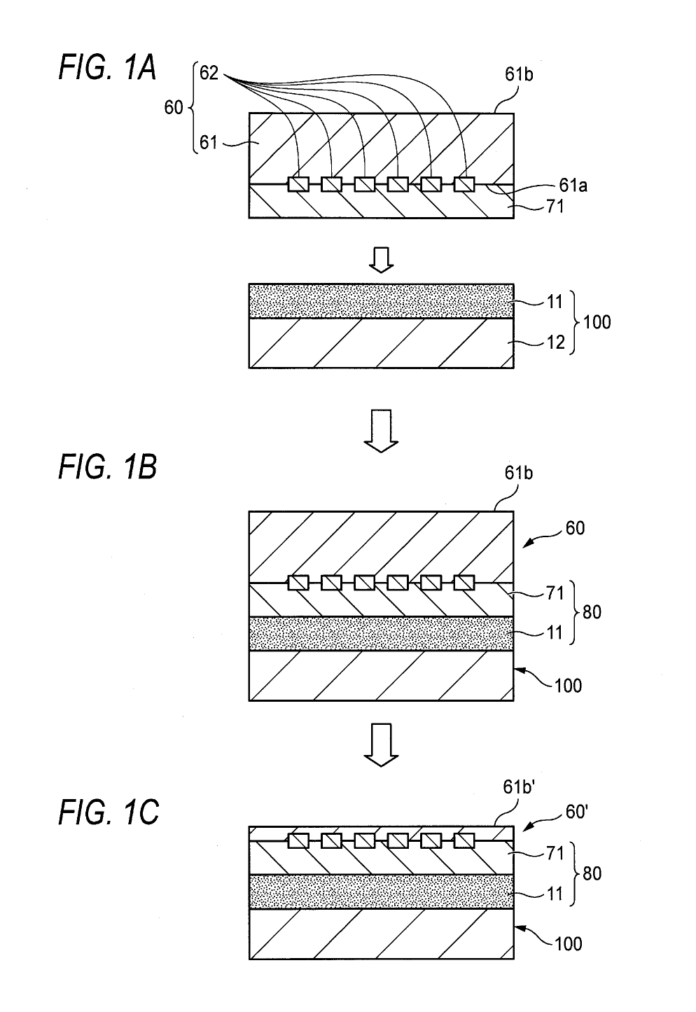

FIG. 1A, FIG. 1B and FIG. 1C are a schematic cross-sectional view illustrating temporary adhesion of an adhesive support and a device wafer, a schematic cross-sectional view showing the device wafer temporarily adhered by the adhesive support and a schematic cross-sectional view showing a state in which the device wafer temporarily adhered by the adhesive support is thinned, respectively.

According to an embodiment of the invention, first, an adhesive support 100 having an adhesive layer 11 provided on a carrier substrate 12 is prepared as shown in FIG. 1A.

A material of the carrier substrate 12 is not particularly limited and includes, for example, a silicon substrate, a glass substrate and a metal substrate. Taking those into consideration that a silicon substrate which is typically used as a substrate of semiconductor device is hardly contaminated and that an electrostatic chuck which is commonly used in the process of producing a semiconductor device can be used, a silicon substrate is preferred.

The thickness of the carrier substrate 12 is, for example, in a range from 300 μm to 5 mm, and it is not particularly limited.

The adhesive layer 11 can be formed by coating the temporary adhesive composition for production of semiconductor device according to the invention on the carrier substrate 12 by using a conventionally known method, for example, a spin coating method, a spraying method, a roller coating method, a flow coating method, a doctor coating method or a dipping method, followed by drying.

The thickness of the adhesive layer 11 is, for example, in a range from 1 to 500 μm, and it is not particularly limited.

Then, temporary adhesion of the adhesive support obtained as described above and a device wafer, thinning of the device wafer and release of the device wafer from the adhesive support will be described in detail.

As shown in FIG. 1A, the device wafer 60 (member to be processed) has a plurality of device chips 62 provided on a surface 61a of silicon substrate 61. Further, a release layer 71 is provided on a surface of the device chip 62 side of device wafer 60.

The thickness of the silicon substrate 61 is, for example, in a range from 200 to 1,200 μm.

The surface of release layer 71 is pressed against the adhesive layer 11 of the adhesive support 100. Thus, as shown in FIG. 1B, the release layer 71 and the adhesive layer 11 are adhered, whereby the adhesive support 100 and the device wafer 60 are temporarily adhered. Thus, a temporary bonding layer 80 having the release layer 71 and the adhesive layer 11 is formed.

Also, after that, if desired, the adhesion body composed of the adhesive support 100 and the device wafer 60 may be heated (subjected to irradiation of heat), thereby making the adhesive layer more tough. Thus, since the cohesion failure of the adhesive layer, which may likely occur when the device wafer 60 is subjected to a mechanical or chemical processing described later, can be prevented, the adhesion property of the adhesive support 100 is increased. In particular, from the standpoint of accelerating the crosslinking reaction of the reactive compound having a crosslinkable group with heat, the adhesive layer 11 preferably contains the heat polymerization initiator.

The heating temperature is preferably from 50 to 300° C.

Then, a rear surface 61b of the silicon substrate 61 is subjected to a mechanical or chemical processing, specifically, a thinning processing, for example, grinding or chemical mechanical polishing (CMP) to reduce the thickness of the silicon substrate 61 (for example, to make the thickness of 1 to 200 μm), thereby obtaining a thin device wafer 60′ as shown in FIG. 1C.

Also, as the mechanical or chemical processing, after the thinning processing a processing of forming a through hole (not shown) passing through the silicon substrate from the rear surface 61b′ of the thin device wafer 60′ and forming a though-silicone electrode (not shown) in the through hole may be performed, if desired.

Then, the surface 61a of the thin device wafer 60′ is released from the adhesive layer 11 of the adhesive support 100.

A method for the release is not particularly limited, and it is preferably performed by bringing the temporary bonding layer 80 into contact with a release solution and then, if desired, sliding the thin device wafer 60′ to the adhesive support 100 or stripping the thin device wafer 60′ from the adhesive support 100. Since the release layer 71 of the temporary bonding layer 80 has a high affinity to the release solution, the temporary adhesion between the adhesive layer 11 and the surface 61a of the thin device wafer 60′ can be easily released by means of the method described above.

After releasing the thin device wafer 60′ from the adhesive support 100, if desired, the thin device wafer 60′ is subjected to various known processings, thereby producing a semiconductor device having the thin device wafer 60′.

The release solution is described in detail below.

As the release solution, a solvent which dissolves the hydrocarbon resin of the release layer is used without particular limitation and, for example, at least one solvent selected from the group consisting of a hydrocarbon solvent and an ether solvent can be preferably used. Examples of the hydrocarbon solvent include a straight-chain or branched alkane and a cycloalkane. Specifically, for example, pentane, cyclopentane, 2-methylbutane, 3-methylpentane, hexane, 2,2-dimethylbutane, 2,3-dimethylbutane, heptane, octane, 2,2,4-trimethylpentane, 2,2,3-trimethylhexane, nonane, decane, undecane, dodecane, 2,2,4,6,6-pentamethylheptane, tridecane, pentadecane, tetradecane, hexadecane, cyclopentane, cyclohexane, cycloheptane or cyclooctane can be used. The organic solvents can be used individually or as a mixture of two or more thereof. Also, a terpene saturated hydrocarbon can be used as the solvent. Specifically, for example, pinane, bornane, carane, fenchane, thujane, o-menthane, m-menthane, p-menthane, diphenyl menthane, limonene, α-terpinene, β-terpinene, γ-terpinene, bornane, norbornane, pinane, α-pinene, β-pinene, carane, longifolene and abietane are exemplified. Further, tetrahydrofuran (abbreviation: THF) can be preferably used.

The number of carbon atoms of the saturated hydrocarbon solvent is preferably from 6 to 10, and more preferably from 7 to 9. From the standpoint of suppression of volatilization of the solvent, the number of the carbon atoms of the saturated hydrocarbon solvent is preferably 6 or more, and more preferably 7 or more.

As the ether solvent, tetrahydrofuran, cyclopentyl methyl ether, tert-butyl methyl ether and anisole can be used.

The number of carbon atoms of the ether solvent is preferably from 4 to 10, and more preferably from 4 to 9. From the standpoint of suppression of volatilization of the solvent, the number of the carbon atoms of the ether solvent is preferably 4 or more.

The release solution is preferably cyclopentane, n-hexane, cyclohexane, n-heptane, limonene, p-menthane or tetrahydrofuran.

In the invention, the method of temporary adhesion is not limited as long as the device wafer and the carrier substrate are adhered so that the temporary bonding layer having the release layer and the adhesive layer is intervened therebetween, and the temporary bonding layer having the release layer provided on the adhesive layer is previously formed and the carrier substrate and the device wafer may be bonded to the adhesive layer and the release layer, respectively.

Also, the invention relates to a stack comprising a support, for example, a carrier substrate, a member to be processed, for example, a device wafer, and a temporary bonding layer provided between the support and the member to be processed.

Now, a conventional embodiment is described.

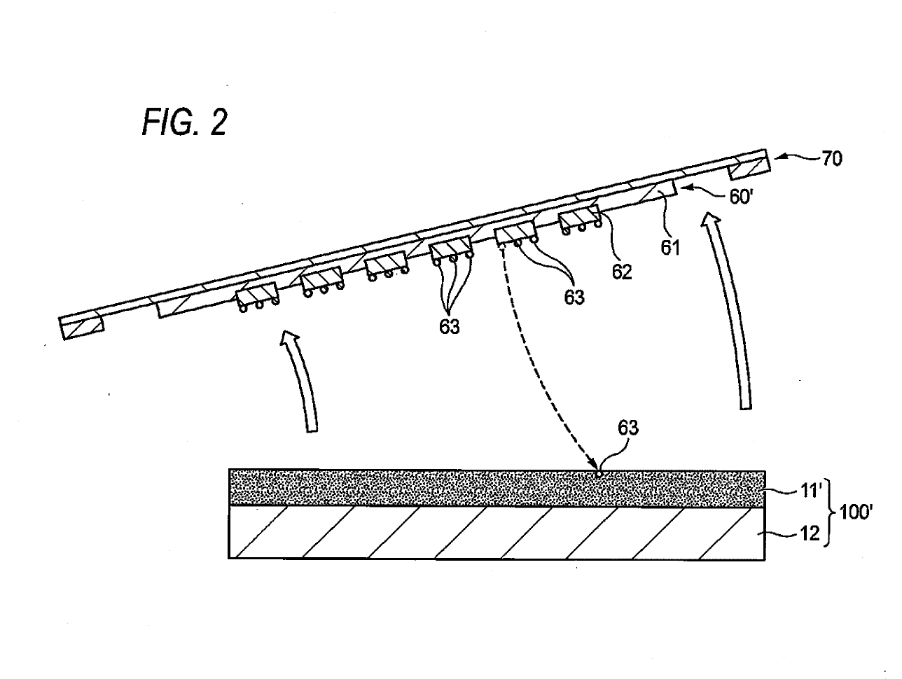

FIG. 2 is a schematic cross-sectional view illustrating release of a temporary adhering state between a conventional adhesive support and a device wafer.

In the conventional embodiment, as shown in FIG. 2, except for using as the adhesive support, an adhesive support 100′ having an adhesive layer 11′ formed from a conventional temporary adhesive provided on a carrier substrate 12, the temporary adhesion of the adhesive support 100′ to a device wafer and the thinning processing of the silicon substrate in the device wafer are performed by the same procedures as described with reference to FIG. 1A and FIG. 1B, and then a thin device wafer 60′ is released from the adhesive support 100′ by the same procedure as described with reference to FIG. 1C.

However, according to the conventional temporary adhesive it is difficult not only to temporarily support a member to be processed firmly and easily but also to easily release the temporary support for the member processed without imparting damage to the member processed. For example, when a temporary adhesive having a high adhesion property of the conventional temporary adhesives is adopted in order to perform sufficiently temporary adhesion between a device wafer and a carrier substrate, the temporary adhesion between the device wafer and the carrier substrate tends to become too strong. Thus, for example, as shown in FIG. 2, in the case where a tape (for example, a dicing tape) 70 is adhered on a rear surface of a thin device wafer 60′ and the thin device wafer 60′ is released from the adhesive support 100′ for the purpose of releasing such a strong temporary adhesion, an inconvenience is apt to occur in that a device chip 62 is damaged, for example, a bump 63 is released from the device chip 62 having provided thereon the bump 63.

On the other hand, when a temporary adhesive having a low adhesion property of the conventional temporary adhesives is adopted, the temporary adhesion between a device wafer and a carrier substrate is too weak so that an inconvenience is apt to occur in that the device wafer cannot be firmly supported by the carrier substrate.

However, the adhesive layer formed from the adhesive composition according to the invention exhibits a sufficient adhesion property, and the temporary adhesion between the device wafer 60 and the adhesive support 100 can be easily released particularly by bringing the adhesive layer 11 into contact with the release solution. Specifically, due to the release layer 71 of the temporary bonding layer 80 according to the invention, not only the device wafer 60 can temporarily support firmly and easily but also the temporary support for the thin device wafer 60′ can be easily released without imparting damage to the thin device wafer 60′.

Further, particularly in the case where the adhesive composition (therefore the adhesive layer) according to the invention further contains together with the photopolymerization initiator or the heat polymerization initiator, the radical polymerizable compound, the adhesive layer 11 can be made as an adhesive layer in which the adhesion property decreases by the irradiation of active light or radiation, or heat. Specifically, the adhesive layer can be made as a layer which has an adhesive property before being subjected to the irradiation of active light or radiation, or heat and in which the adhesion property is decreased or lost in the region to which active light or radiation, or heat is irradiated.

Therefore, according to the invention, before adhering the adhesive support 100 to the device wafer 60, active light or radiation, or heat may be irradiated to a surface of the adhesive surface 11 of the adhesive support 100, which is to be adhered to the release layer 71.

For example, the adhesive layer is converted to an adhesive layer in which a low adhesive region and a high adhesive region are formed by the irradiation of active light or radiation, or heat, and then temporary adhesion of the adhesive support to the member to be processed may be performed. This embodiment described below.

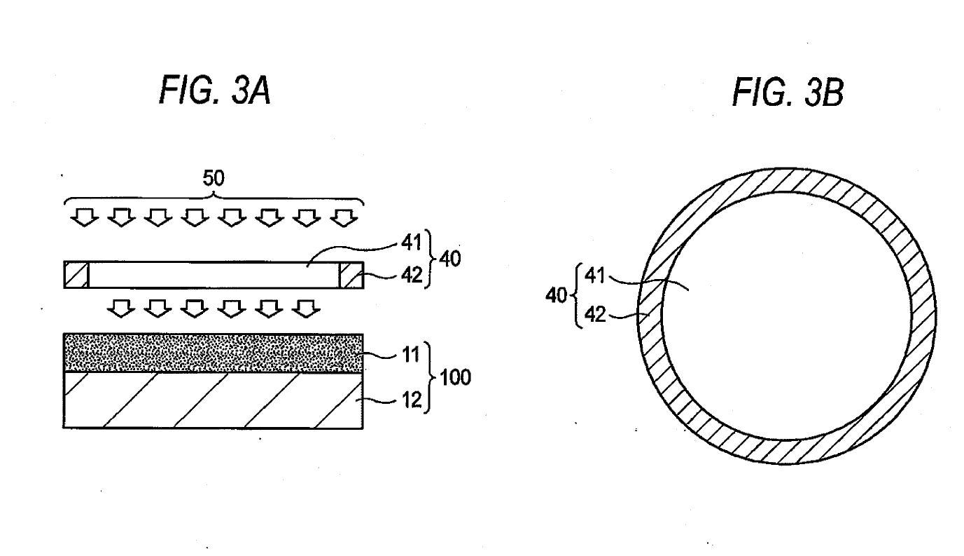

FIG. 3A shows a schematic cross-sectional view illustrating exposure of the adhesive support, and FIG. 3B shows a schematic top view of a mask.

First, the adhesive layer 11 of the adhesive support 100 is irradiated by active light or radiation 50 (that is exposed) through a mask 40.

As shown in FIG. 3A and FIG. 3B, the mask 40 is composed of a light-transmitting region 41 provided in the central area and a light-shielding region 42 provided in the peripheral area.

Thus, the exposure described above is a pattern exposure in which the central area of the adhesive layer 11 is exposed, but the peripheral area surrounding the central area is not exposed.

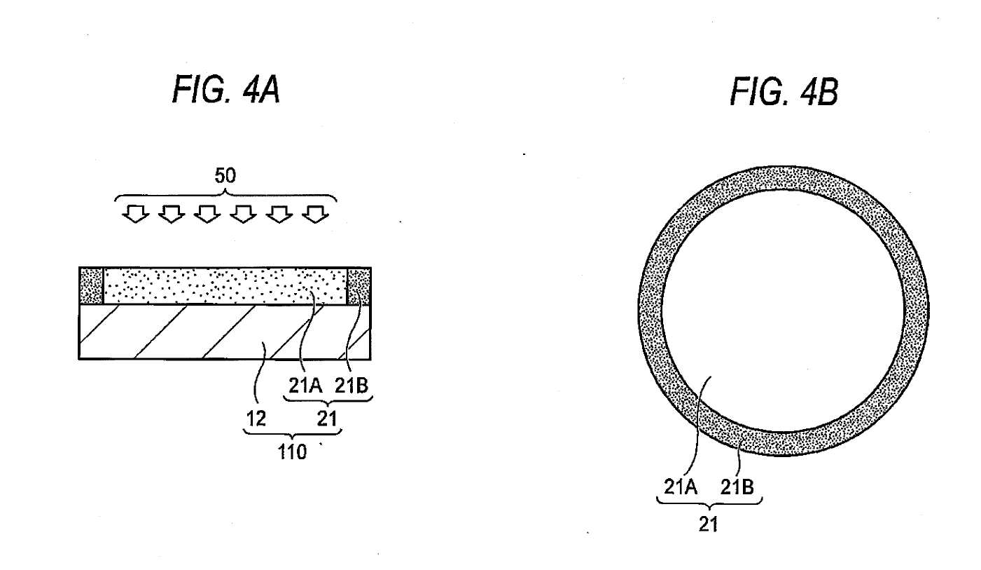

FIG. 4A shows a schematic cross-sectional view of the adhesive support subjected to pattern exposure, and FIG. 4B shows a schematic top view of the adhesive support subjected to pattern exposure.

As described above, in the case where the adhesive layer 11 is an adhesive layer in which the adhesion property decreases by the irradiation of active light or radiation, the adhesive support 100 is converted to an adhesive support 110 having an adhesive layer 21 in which a low adhesive region 21A and a high adhesive region 21B are formed in the central area and the peripheral area, respectively, as shown in FIG. 4A and FIG. 4B.

In the specification, the term “low adhesive region” means a region having a low adhesion property in comparison with the “high adhesive region” and includes a region having no adhesion property (specifically, a “non-adhesive region”). Similarly, the term “high adhesive region” means a region having a high adhesion property in comparison with the “low adhesive region”.

In the adhesive support 110, the low adhesive region 21A and the high adhesive region 21B are provided by the pattern exposure using the mask 40, the respective areas and shapes of the light-transmitting region and the light-shielding region in the mask 40 can be controlled in an order of micron to nanometer. Thus, since the respective areas and shapes of the high adhesive region 21B and the low adhesive region 21A formed in the adhesive layer 21 of the adhesive support 110 can be finely controlled by the pattern exposure, the adhesion property of the adhesive layer as a whole can be controlled in a high accuracy and easily to an adhesive property in such a degree that not only the silicon substrate 61 of the device wafer 60 is temporarily supported more firmly and easily but also the temporary support for the silicon substrate of the thin display wafer 60′ is more easily released without imparting damage to the thin display wafer 60′.

Also, in the high adhesive region 21B and the low adhesive region 21A in the adhesive support 110, the surface properties thereof are differentiated by the pattern exposure, but they are integrated as a structure. Therefore, there is no large difference in the mechanical properties between the high adhesive region 21B and the low adhesive region 21A, and even when the surface 61a of the silicon substrate 61 of the device wafer 60 is adhered to the adhesive layer 21 of the adhesive support 110, and then the rear surface 61b of the silicon substrate 61 is subjected to the thinning processing or the processing for forming a through-silicone electrode, a difference in the pressure relating to the processing (for example, grinding pressure or a polishing pressure) hardly arises between the region of the back surface 61b corresponding to the high adhesive region 21B of the adhesive layer 21 and the region of the back surface 61b corresponding to the low adhesive region 21A, and the influence of the high adhesive region 21B and the low adhesive region 21A on the processing accuracy in the processing described above is small. This is particularly effective in the case of obtaining a thin device wafer 60′ having a thickness, for example, from 1 to 200 μm, which is likely to cause the problem described above.

Therefore, the embodiment using the adhesive support 110 is preferred as an embodiment wherein the silicon substrate 61 can be temporarily supported more firmly and easily while suppressing the influence on the processing accuracy when the silicon substrate 61 of the device wafer 60 is subjected to the processing described above and the temporary support for the thin display wafer 60′ can be more easily released without imparting damage to the thin display wafer 60′.

Also, in the case where the adhesive layer 11 is an adhesive layer in which the adhesion property decreases by the irradiation of active light or radiation, or heat, for example, the adhesive layer is converted to an adhesive layer in which the adhesion property decreases towards the outer surface from the inner surface on the substrate side by the irradiation of active light or radiation, or heat, and then temporary adhesion of the adhesive support to the member to be processed may be performed. This embodiment is described below.

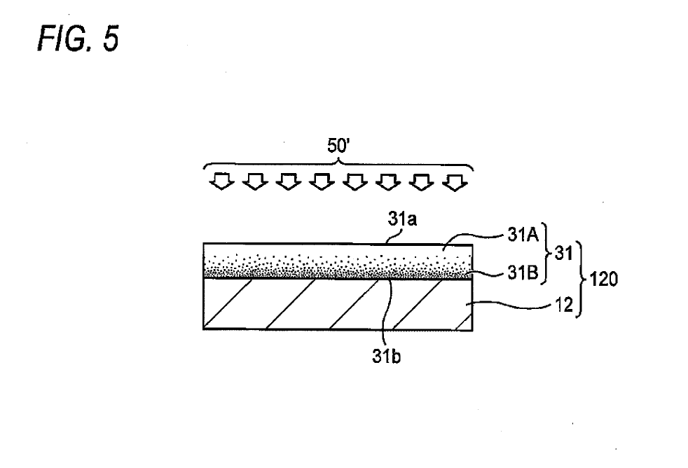

FIG. 5 is a schematic cross-sectional view illustrating irradiation of active light or radiation, or heat to the adhesive support.

First, active light or radiation, or heat 50′ is irradiated to the outer surface of the adhesive layer 11, whereby the adhesive support 100 is converted into an adhesive support 120 having an adhesive layer 31 in which the adhesion property is decreased toward the outer surface 31a from the inner surface 31b on the substrate side, as shown in FIG. 5.

Specifically, the adhesive layer 31 comes to have a low adhesive region 31A and a high adhesive region 31B on the outer surface 31a side and the inner surface 31b side, respectively.

Such an adhesive layer 31 can be easily formed by controlling the irradiation dose of the active light or radiation, or heat 50′ to such an irradiation dose that the active light or radiation, or heat 50′ sufficiently irradiates the outer surface 31a, but the active light or radiation, or heat 50′ does not reach to the inner surface 31b.

The change in the irradiation dose as described above can be easily performed by changing the setting of an exposure machine or a heating device so that not only the cost of equipment can be reduced but also formation of the adhesive layer 21 or 31 can be performed without spending a long time.

As described above, the formation of the adhesive layer 31 is easy.

Further, each of the adhesion property on the outer surface 31a and the adhesion property on the inner surface 31b can be controlled with good precision, for example, by selecting the material constituting the adhesive layer 11 and adjusting the irradiation dose of the active light, radiation or heat.

As a result, the adhesion property of the adhesive layer 31 to each of the substrate 12 and the silicon substrate 61 can be easily controlled with high precision to such a degree of adhesion property that not only the silicon substrate 61 of the device wafer 60 can be temporarily supported firmly and easily but also the temporary support for the silicon substrate of the thin device wafer 60′ can be easily released without imparting damage to the thin device wafer 60′.

Therefore, the embodiment using the adhesive support 120 is also preferred as an embodiment wherein not only the silicon substrate 61 can be temporarily supported more firmly and easily when the silicon substrate 61 of the device wafer 60 is subjected to the processing described above but also the temporary support for the thin display wafer 60′ can be more easily released without imparting damage to the thin display wafer 60′.

The production method of semiconductor device according to the invention is not limited to the embodiments described above, and appropriate modifications, improvements and the like can be made therein.

In the embodiments described above, the adhesive layer formed from the adhesive composition according to the invention is provided on the carrier substrate before the temporary adhesion of a device wafer to constitute the adhesive support, but the adhesive layer may be formed on the release layer to form first the temporary bonding layer, and in this case the adhesive layer and the release layer of the temporary bonding layer are adhered to the carrier substrate and the device wafer, respectively.

For example, a mask used for the pattern exposure may be a binary mask or a halftone mask.

Also, the exposure is mask exposure through a mask, but may be selective exposure by drawing using also an electron beam or the like.

In the embodiments described above, the adhesive layer has a single-layer structure, but the adhesive layer may have a multilayer structure. Examples of the method for forming an adhesive layer having a multilayer structure include a method of stepwise coating an adhesive composition by the conventionally known method described above before irradiation of active light or radiation, and a method of coating an adhesive composition by the conventionally known method described above after irradiation of active light or radiation. In the embodiment where the adhesive layer has a multilayer structure, for example, in the case where the adhesive layer 11 is an adhesive layer in which the adhesion property decreases by the irradiation of active light or radiation, or heat, the adhesion property as an entire adhesive layer can also be decreased by decreasing the adhesion property between respective layers by the irradiation of active light or radiation, or heat.

In the embodiments described above, the member to be processed which is supported by the adhesive support is a silicon substrate, but the member to be processed is not limited thereto and may be any member to be processed which can be subjected to a mechanical or chemical processing in the production method of semiconductor device.

For example, the member to be processed includes a compound semiconductor substrate, and specific examples of the compound semiconductor substrate include an SiC substrate, an SiGe substrate, a ZnS substrate, a ZnSe substrate, a GaAs substrate, an InP substrate and a GaN substrate.

Further, in the embodiments described above, the mechanical or chemical processing applied to the silicon substrate which is supported by the adhesive support is the thinning processing of the silicon substrate or the processing for forming a through-silicon electrode, but the mechanical or chemical processing is not limited thereto and may be any processing required in the production method of semiconductor device.

In addition, the light-transmitting region and the light-shielding region in the mask, the high adhesive region and the low adhesive region in the adhesive layer, and the shape, dimension, number, arrangement portion and the like of device chip in the device wafer, which are exemplified in the embodiments described above, are arbitrary and not limited as long as the invention can be achieved.

### EXAMPLES

The invention will be described more specifically with reference to the examples, but the invention should not be construed as being limited thereto as long as the gist of the invention is not deviated. All “part” and “%” therein are weigh basis unless otherwise specified.

### <Formation of Adhesive Support>

Each liquid adhesive composition having the composition shown in Table 1 below was coated on a 4-inch Si wafer by a spin coater (Opticoat MS-A100, produced by Mikasa Co., Ltd., 1,200 rpm, 30 seconds) and then baked at 100° C. for 30 seconds to form Wafer 1 having provided thereon an adhesive layer having a thickness of 10 μm (that is, an adhesive support).

TABLE 1

| | Polymer Compound | | Polymerizable | | Photopolymerization | | Heat Polymerization | | | |
|---|---|---|---|---|---|---|---|---|---|---|
| | (Binder) | | Monomer | | Initiator | | Initiator | | Solvent | |
| | | Content | | Content | | Content | | Content | | Content |
| | | (parts by | | (parts by | | (parts by | | (parts by | | (parts by |
| | Kind | weight) | Kind | weight) | Kind | weight) | Kind | weight) | Kind | weight) |
| Adhesive | Polymer | 50 | Polymerizable | 50 | Photopolymerization | 5 | Heat | 5 | S1 | 150 |
| Composition | Compound | | Monomer (1) | | Initiator (1) | | Polymerization | | | |
| 1 | (1) | | | | | | Initiator (1) | | | |
| Adhesive | Polymer | 50 | Polymerizable | 50 | Photopolymerization | 5 | Heat | 5 | S2 | 150 |
| Composition | Compound | | Monomer (2) | | Initiator (1) | | Polymerization | | | |
| 2 | (2) | | | | | | Initiator (1) | | | |
| Adhesive | Polymer | 30 | Polymerizable | 70 | Photopolymerization | 5 | Heat | 5 | S3 | 150 |
| Composition | Compound | | Monomer (3) | | Initiator (1) | | Polymerization | | | |
| 3 | (3) | | | | | | Initiator (1) | | | |
| Adhesive | Polymer | 50 | Polymerizable | 50 | None | 0 | Heat | 5 | S1 | 200 |
| Composition | Compound | | Monomer (1) | | | | Polymerization | | | |
| 4 | (1) | | | | | | Initiator (1) | | | |
| Adhesive | Polymer | 50 | Polymerizable | 50 | Photopolymerization | 5 | None | 0 | S1 | 250 |
| Composition | Compound | | Monomer (1) | | Initiator (1) | | | | | |
| 5 | (1) | | | | | | | | | |

The compounds shown in Table 1 are as follows.

S1: Methyl amyl ketone
S2: Propylene glycol monomethyl ether acetate (PGMEA)
S3: N-Methyl-2-pyrrolidone

### [Binder]

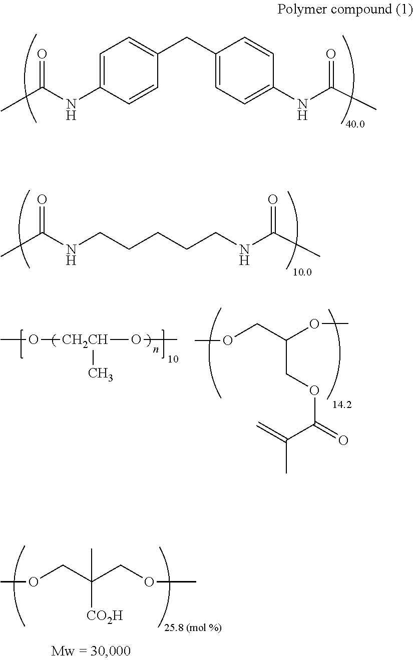

Polymer Compound (2): NK OLIGO EA7440 (novolac resin having a carboxylic acid group and a radical polymerizable group, produced by Shin-Nakamura Chemical Co., Ltd.)
Polymer Compound (3): Durimide 10 (polyimide resin, produced by Fujifilm Corp.)

### [Polymerizable Monomer]

Polymerizable monomer (1): UA-1100H (tetrafunctional urethane acrylate, produced by Shin-Nakamura Chemical Co., Ltd.)
Polymerizable monomer (2): A-TMPT (trimethylolpropane triacrylate, produced by Shin-Nakamura Chemical Co., Ltd.)
Polymerizable monomer (3): 2,2-Bis(4-glycidyloxyphenyl)propane, produced by Tokyo Chemical Industry Co., Ltd.)

### [Photopolymerization Initiator]

Photopolymerization Initiator (1): IRGACURE OXE 02 (produced by BASF Corp.)

### [Heat Polymerization Initiator]

Heat Polymerization Initiator (1): PERBUTYL Z (tert-butyl peroxybenzoate, produced by NOF Corp.)

### <Preparation of Member to be Processed>

Each liquid release layer composition having the composition shown in Table 2 below was coated on a 4-inch Si wafer by a spin coater (Opticoat MS-A100, produced by Mikasa Co., Ltd., 1,200 rpm, 30 seconds) and then baked at 100° C. for 300 seconds to form Wafer 2 having provided thereon a release layer having a thickness of 20 μm (that is, a member to be processed).

TABLE 2

| | Polymer Compound | | Solvent | |
|---|---|---|---|---|
| | | Content | | Content |
| | Kind | (%) | Kind | (%) |
| Resin Solution 1 | Hydrocarbon Resin (1) | 25 | Limonene | 75 |
| Resin Solution 2 | Hydrocarbon Resin (2) | 25 | Limonene | 75 |
| Resin Solution 3 | Hydrocarbon Resin (3) | 25 | Limonene | 75 |
| Resin Solution 4 | Hydrocarbon Resin (4) | 10 | Cyclopentane | 90 |
| Resin Solution 5 | Hydrocarbon Resin (5) | 25 | Limonene | 75 |
| Resin Solution 6 | Hydrocarbon Resin (6) | 25 | Limonene | 75 |
| Resin Solution 7 | Comparative Resin (1) | 10 | N-Methyl-2-pyrrolidone | 90 |
| Resin Solution 8 | Comparative Resin (2) | 20 | PGMEA | 80 |
| Resin Solution 9 | Comparative Resin (3) | 20 | PGMEA | 80 |

| | |
|---|---|
| Resin Solution 10 | 25% by weight PGMEA solution of silver (Ag) and |
| | silver tin compound (AgSn) |

Hydrocarbon Resin (1): CLEARON P-135 (produced by Yasuhara Chemical Co., Ltd.)
Hydrocarbon Resin (2): ZEONEX 480R (produced by Zeon Corp.)
Hydrocarbon Resin (3): TOPAS 5013 (produced by Polyplastics Co., Ltd.)
Hydrocarbon Resin (4): TPX-MX002 (produced by Mitsui Chemicals, Inc.)
Hydrocarbon Resin (5): Polystyrene (Mw: 190,000, produced by Sigma-Aldrich Corp.)
Hydrocarbon Resin (6): PENSEL KK (produced by Arakawa Chemical Industries, Ltd.)
Comparative Resin (1): MACROMELT 6901 (nylon, produced by Henkel Co.)
Comparative Resin (2): Repeating unit represented by formula (3) shown below: Repeating unit represented by formula (1) shown below=50:50 (in molar ratio), Molecular weight: 8,000
Comparative Resin (3): Repeating unit represented by formula (6) shown below: Repeating unit represented by formula (7) shown below=70:30 (in molar ratio), Molecular weight: 6,500

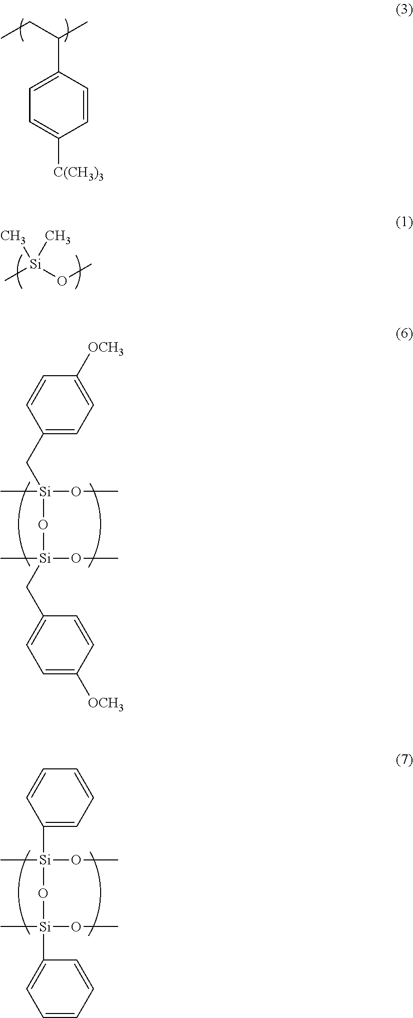

### <Preparation of Stack Test Piece>

Wafer 1 and Wafer 2 were bonded with pressure according to the combination described in Table 3 shown below and baked to prepare test pieces. Methods of the bonding with pressure and the baking are described below.

[Bonding with Pressure]

A 4-inch Si wafer having no coating on its surface thereof and a 4-inch Si wafer having a release layer (hereinafter, referred to as Wafer 2) were split to form sample pieces of 5 mm×20 mm. Wafer 1 was split in the same manner to form a sample piece of 5 mm×20 mm. The adhesive layer of the sample piece of Wafer 1 was superimposed on the sample piece of the 4-inch Si wafer having no coating on its surface thereof or on the release layer of the sample piece of Wafer 2 so as to contact with a square of 5 mm×5 mm and adhered under pressure of 20N/cm² at 25° C. for 30 seconds.

### [Baking]

The wafers adhered were heated at 180° C. for 60 seconds.

### <Adhesive Force Measurement of Stack Test Piece>

As to the shear adhesive force of the stack test piece prepared, tensile measurement was performed in the direction along the surface of the adhesive layer under the condition of 250 mm/min using a tensile tester (Model: ZP-50N, produced by Imada Co., Ltd.). The measurements were performed at 25° C. and 100° C. The results are shown in Table 3 below.

### <Releasing Property Measurement of Releasing Property Test Piece>

The stack test piece prepared was immersed in the release solution shown in Table 3 at 25° C. It was immersed until the two sample pieces were released spontaneously and a period for the release was measured. The results are shown in Table 3 below.

### <Chemical Resistance Measurement of Stack Test Piece>

The stack test piece prepared was immersed in the chemical solution shown in Table 3 at 25° C. for 60 minutes. The case where the two sample pieces were released spontaneously during the immersion was ranked as B and the case where the two sample pieces were not released was ranked as A. The results are shown in Table 3 below.

TABLE 3

| | | | | | | | Chemical Resistance | | | | |
|---|---|---|---|---|---|---|---|---|---|---|---|
| | | | Adhesive | | | | | | | 2.38% | 1.2N |
| | | | Forth | | | Releasing | | | | Aqueous | Aqueous |
| | Adhesive | Release | (N/25 mm²) | | Release | Property | | Cyclo- | | TMAH | HCL |
| | Layer | Layer | 25° C. | 100° C. | Solution | (min) | NMP | hexanone | PGMEA | Solution | Solution |
| Comparative | Adhesive | None | 25 | 12 | THF | >120 | A | A | A | A | A |
| Example 1 | Composition 1 | | | | | | | | | | |
| Comparative | None | Resin | 5 | 0 | Hexane | 25 | A | A | A | A | A |
| Example 2 | | Solution (1) | | | | | | | | | |
| Comparative | Adhesive | Resin | 20 | 7 | THF | 60 | B | B | A | A | A |
| Example 3 | Composition 1 | Solution (7) | | | | | | | | | |
| Comparative | Adhesive | Resin | 15 | 5 | Hexane | 60 | B | B | B | A | A |
| Example 4 | Composition 1 | Solution (8) | | | | | | | | | |
| Comparative | Adhesive | Resin | 18 | 5 | THF | 60 | B | B | B | A | A |
| Example 5 | Composition 1 | Solution (9) | | | | | | | | | |
| Comparative | Adhesive | Resin | 20 | 7 | THF | 60 | B | B | B | A | A |
| Example 6 | Composition 1 | Solution (10) | | | | | | | | | |
| Example 1 | Adhesive | Resin | 25 | 13 | Hexane | 25 | A | A | A | A | A |
| | Composition 1 | Solution (1) | | | | | | | | | |
| Example 2 | Adhesive | Resin | 28 | 28 | THF | 10 | A | A | A | A | A |
| | Composition 1 | Solution (2) | | | | | | | | | |
| Example 3 | Adhesive | Resin | 29 | 29 | THF | 10 | A | A | A | A | A |
| | Composition 1 | Solution (3) | | | | | | | | | |
| Example 4 | Adhesive | Resin | 25 | 25 | Cyclopentane | 20 | A | A | A | A | A |
| | Composition 1 | Solution (4) | | | | | | | | | |
| Example 5 | Adhesive | Resin | 30 | 30 | Hexane | 10 | A | A | A | A | A |
| | Composition 1 | Solution (5) | | | | | | | | | |
| Example 6 | Adhesive | Resin | 25 | 13 | Hexane | 20 | A | A | A | A | A |
| | Composition 1 | Solution (6) | | | | | | | | | |
| Example 7 | Adhesive | Resin | 25 | 12 | THF | 25 | A | A | A | A | A |
| | Composition 2 | Solution (1) | | | | | | | | | |
| Example 8 | Adhesive | Resin | 25 | 12 | THF | 25 | A | A | A | A | A |
| | Composition 3 | Solution (1) | | | | | | | | | |
| Example 9 | Adhesive | Resin | 25 | 13 | THF | 25 | A | A | A | A | A |
| | Composition 4 | Solution (1) | | | | | | | | | |
| Example 10 | Adhesive | Resin | 22 | 10 | THF | 25 | A | A | A | A | A |
| | Composition 5 | Solution (1) | | | | | | | | | |

The abbreviations shown in Table 3 are as follows.

### THF: Tetrahydrofuran

NMP: N-methyl-2-pyrrolidone
TMAH: Tetramethylammonium hydroxide

As described above, it can be seen that in Comparative Example 1 having no release layer, the releasing property is insufficient although the adhesion property is obtained, in Comparative Example 2 having no adhesive layer, the adhesion property is insufficient, and in Comparative Examples 3 to 6 wherein the release layer is a layer not containing the hydrocarbon resin, the releasing property and the chemical resistance (resistance to NMP, cyclohexanone or PGMEA) are insufficient, but on the contrary, in the examples a good balance between the adhesion property and the releasing property can be achieved by using the temporary bonding layer according to the invention.

Also, in all of the examples exclusive of Example 9, the adhesion property between the adhesive layer and the release layer was not developed at all when the exposure process described below was performed.

### [Exposure]

The adhesive layer of Wafer 1 was exposed with light having a wavelength of 254 nm at an exposure dose of 500 mJ/cm² using an UV exposure device (LC8, produced by Hamamatsu Photonics K.K.).

Therefore, since a high adhesive region and a low adhesive region can be formed in the adhesive layer by using such an adhesive layer as the adhesive layer of the adhesive support and performing pattern exposure to the adhesive layer (that is, providing the exposed area and the unexposed area), it is possible that not only the member to be processed is temporarily supported firmly and easily while suppressing the influence on the processing accuracy when the member to be processed is subjected to a mechanical or chemical processing, but also the temporary support for the member processed is released without imparting damage to the member processed.

### INDUSTRIAL APPLICABILITY

According to the invention, a temporary bonding layer for production of semiconductor device, which not only can temporarily support a member to be processed (for example, a semiconductor wafer) firmly and easily when the member to be processed is subjected to a mechanical or chemical processing, but also can easily release the temporary support for the member processed without imparting damage to the member processed, a stack and a production method of semiconductor device can be provided.

Although the invention has been described in detail and by reference to specific embodiments, it is apparent to those skilled in the art that it is possible to add various alterations and modifications insofar as the alterations and modifications do not deviate from the spirit and the scope of the invention.

This application is based on a Japanese patent application filed on Sep. 28, 2012 (Japanese Patent Application No. 2012-218586), and the contents thereof are incorporated herein by reference.

1. A temporary bonding layer for production of semiconductor device comprising (A) a release layer and (B) an adhesive layer, wherein the release layer contains a hydrocarbon resin.

2. The temporary bonding layer for production of semiconductor device as claimed in claim 1, wherein the hydrocarbon resin is at least one resin selected from the group consisting of a polystyrene resin, an olefin polymer, a cyclic olefin polymer, a terpene resin, rosin and a petroleum resin.

3. The temporary bonding layer for production of semiconductor device as claimed in claim 1, wherein the hydrocarbon resin is a polystyrene resin or a cyclic olefin polymer.

4. The temporary bonding layer for production of semiconductor device as claimed in claim 2, wherein the hydrocarbon resin is a polystyrene resin or a cyclic olefin polymer.

5. The temporary bonding layer for production of semiconductor device as claimed in claim 1, wherein the adhesive layer contains a binder, a polymerizable monomer, and at least one of a photopolymerization initiator and a heat polymerization initiator.

6. The temporary bonding layer for production of semiconductor device as claimed in claim 2, wherein the adhesive layer contains a binder, a polymerizable monomer, and at least one of a photopolymerization initiator and a heat polymerization initiator.

7. A stack comprising a support, a member to be processed, and the temporary bonding layer as claimed in claim 1 which is provided between the support and the member to be processed.

8. A production method of semiconductor device having a member processed, comprising:
adhering a first surface of a member to be processed to a substrate in such a manner that the temporary bonding layer as claimed in claim 1 is intervened between the first surface of a member to be processed and the substrate;
conducting a mechanical or chemical processing on a second surface of the member to be processed which is different from the first surface of the member to be processed to obtain the member processed; and
releasing the member processed from the temporary bonding layer.

9. The production method of semiconductor device as claimed in claim 8, which further comprises: irradiating active light or radiation, or heat to the adhesive layer of the temporary bonding layer, before the adhering.

10. The production method of semiconductor device as claimed in claim 8, which further comprises: heating the temporary bonding layer at a temperature from 50 to 300° C., after the adhering and before the conducting a mechanical or chemical processing.

11. The production method of semiconductor device as claimed in claim 9, which further comprises: heating the temporary bonding layer at a temperature from 50 to 300° C., after the adhering and before the conducting a mechanical or chemical processing.

12. The production method of semiconductor device as claimed in claim 8, wherein the releasing the member processed from the temporary bonding layer comprises: bringing the temporary bonding layer into contact with a release solvent.

13. The production method of semiconductor device as claimed in claim 9, wherein the releasing the member processed from the temporary bonding layer comprises: bringing the temporary bonding layer into contact with a release solvent.

14. The production method of semiconductor device as claimed in claim 12, wherein the release solvent is at least one solvent selected from the group consisting of a hydrocarbon solvent and an ether solvent.

15. The production method of semiconductor device as claimed in claim 13, wherein the release solvent is at least one solvent selected from the group consisting of a hydrocarbon solvent and an ether solvent.

16. The production method of semiconductor device as claimed in claim 14, wherein the release solvent is at least one solvent selected form the group consisting of cyclopentane, n-hexane, cyclohexane, n-heptane, limonene, p-menthane and tetrahydrofuran.

17. The production method of semiconductor device as claimed in claim 15, wherein the release solvent is at least one solvent selected form the group consisting of cyclopentane, n-hexane, cyclohexane, n-heptane, limonene, p-menthane and tetrahydrofuran.
